(19) United States
(12) Patent Application Publication
(10) Pub. No.: US 2010/0027393 A1
(43) Pub. Date: Feb. 4, 2010

(54) OPTICAL RECORDING MEDIUM, OPTICAL RECORDING APPARATUS, AND SYSTEM TO PREPARE CONTENTS-RECORDED OPTICAL RECORDING MEDIUM

(76) Inventors: Tohru Yashiro, Kanagawa (JP); Yuki Nakamura, Tokyo (JP); Masahiro Hayashi, Kanagawa (JP); Ippei Matsumoto, Kanagawa (JP)

Correspondence Address: COOPER & DUNHAM, LLP, 30 Rockefeller Plaza, 20th Floor, NEW YORK, NY, 10112, US

(21) Appl. No.: 12/442,155

(22) PCT Filed: Mar. 12, 2008
(86) PCT No.: PCT/JP2008/055022

§ 371 Date: Mar. 20, 2009

(30) Foreign Application Priority Data
Mar. 13, 2007 (JP) 2007-063163
Apr. 6, 2007 (JP) 2007-101171
May 18, 2007 (JP) 2007-133314
Jun. 1, 2007 (JP) 2007-147348
Aug. 20, 2007 (JP) 2007-213278
Jan. 30, 2008 (JP) 2008-019158

(51) Int. Cl. G11B 7/00; B32B 3/02

(52) U.S. Cl. 369/53.2; 428/64.8; G9B/7

(57) ABSTRACT

An optical recording medium, comprising a dye recording layer, wherein a recording mark portion is formed at the dye recording layer by use of a laser light having a wavelength of 640 nm to 680 nm, and a reflectance after recording with respect to the laser light at the recording mark portion is increased compared to a reflectance before recording.

### TECHNICAL FIELD

The present invention relates to an optical recording medium, of so-called low-to-high type, that has a dye recording layer capable of recording with DVD laser wavelengths of 640 to 680 nm or blue laser wavelengths of 400 to 410 nm, in which reflectance at recording portions increases or rises upon recording compared to that before recording, and also to an optical recording apparatus and a system to prepare a contents-recorded optical recording medium.

### BACKGROUND ART

In addition to optical recording media such as reproduction-only (read-only) DVD (digital versatile disc), recordable DVD such as DVD+RW, DVD+R, DVD-R, DVD-RW and DVD-RAM have been commercially available. These DVD are extended from conventional CD-R and CD-RW (recordable compact disc) in a technical sense and designed to conform their recording densities (track pitch, signal mark length) and substrate thicknesses with DVD conditions instead of CD conditions in order to assure reproduction compatibility with read-only DVD. Such a configuration is employed in DVD-R, for example, that a dye is spin-coated on a substrate on which guide grooves and/or pits being formed to form an optical recording layer (hereinafter sometimes referred to as “dye recording layer”), a reflective layer is formed on the opposite side of the dye recording layer to prepare an information recording substrate, which is then laminated with another same-shape substrate through a laminating material.

CD-R is characterized by a high reflectance (65%) defined in CD standards (see Patent Literature 1), meanwhile, the optical recording layer should satisfy a certain complex refractive index at the recording/reproducing wavelength of about 650 nm in cases of DVD+R in order to realize higher reflectances in the configuration described above, thus the higher reflectances are advantageously attained by virtue of optical absorbing properties of dye materials when the dye materials are used in the optical recording layer. Accordingly, the dye materials have been used at the optical recording layers in DVD+R similarly as CD-R. These optical recording media make use of properties at edge portions of light absorption bands of light absorption spectra in the dye materials (see FIG. 1), and these optical recording media are already commercially available as recording DVD systems of DVD+R or DVD-R media in which recording is carried out in so-called high-to-low mode to decrease the reflectance (reflective light amount) after the recording compared to before recording.

Recordable DVD capable of high-speed recording has been demanded recently along with enlarging capacity of optical recording media, however, the conventional DVD of high-to-low type suffers from insufficient recording sensitivity or light absorptance and/or insufficient recording properties at high-speed recording since reflectance at recording mark portions before recording is larger than that of after recording.

In addition, optical recording media of high-to-low type, where the reflectance after recording being low compared to before recording, tend to represent larger push-pull signals (=push-pull (differential signal)/reflectance (sum signal)) (in this specification, every occurrences of push-pull signal relates to recording mark portions). In this case, signals due to guide grooves are likely to mix in data signals as a noise component, in particular, when signal noises generate from the guide grooves with a frequency similar to that of data signals, there arises a problem that noise components are hardly removable by use of frequency filters.

Therefore such optical recording media are desirable in which push-pull signals decrease after recording; however, those to decrease push-pull signals after recording have not been publicly known in DVD of cause where low-to-high type itself is not publicly known and also in optical recording media of blue wavelength where low-to-high type is publicly known (see Patent Literatures 2, 3).

In addition, conventional optical recording apparatuses are designed for recordable optical recording media not to record onto access regions (e.g. recording region to manage recording), other than data regions to access at reproducing, for rewriting even after recording being completed to come to unrecorded portions. In conventional optical recording media of high-to-low type, therefore, unrecorded higher reflectance access regions are intermixed within recorded lower reflectance regions etc., whereas in optical recording media of low-to-high type, unrecorded lower reflectance access regions are intermixed within recorded higher reflectance regions etc.

Then commonly used reproducing apparatuses are produced on the basis of conventional optical recording media of high-to-low type (intermixed with higher reflectance access regions), thus it is likely to arise problems of servo failure etc. in the optical recording media of low-to-high type in which lower reflectance access regions being intermixed.

Patent Literature 1: Japanese Patent Application Laid-Open (JP-A) No. 02-42652

Patent Literature 2: JP-A No. 2004-213753

Patent Literature 3: Japanese Patent (JP-B) No. 3834053

### DISCLOSURE OF INVENTION

It is an object of the present invention to provide an optical recording medium of low-to-high type where reflectance is high after recording compared to before recording at recording mark portions, in which the optical recording medium has a dye recording layer capable of recording by use of recording light having a wavelength of 640 to 680 nm or 400 to 410 nm and exhibits excellent recording sensitivity, and also an optical recording apparatus, and a system to prepare a contents-recorded optical recording medium by use of the optical recording apparatus.

As a result of intensive investigation of the present inventors, it has been found that recording sensitivity or light absorptance is sufficient, recording properties are excellent at high-speed recording, and confusion of signals into data signals due to guide grooves can be prevented when DVD is made into an optical recording medium of low-to-high type and also an excellent recoding power margin can be obtained when certain two species of recording dye materials are mixed and used in the recording layer.

That is, the objects described above can be attained by the invention defined in <1> to <18> below.

<1> An optical recording medium, comprising a dye recording layer, wherein a recording mark portion is formed at the dye recording layer by use of a laser light having a wavelength of 640 nm to 680 nm, and the reflectance to the laser light at the recording mark portion is high after recording compared to before recording.
<2> The optical recording medium according to <1>, wherein push-pull signal (push-pull (differential signal)/reflectance (sum signal)) at the recording mark portion is lower after recording compared to before recording.
<3> An optical recording medium, comprising a dye recording layer, wherein a recording mark portion is formed at the dye recording layer by use of a laser light having a wavelength of 400 nm to 410 nm, the reflectance to the laser light at the recording mark portion is high after recording compared to before recording, and push-pull signal (push-pull (differential signal)/reflectance (sum signal)) is lower after recording compared to before recording.
<4> The optical recording medium according to any one of <1> to <3>, wherein the dye recording layer contains one or more dye materials (A) that have a maximum absorption peak wavelength longer than the recording/reproducing wavelength and one or more dye materials (B) that have a maximum absorption peak wavelength shorter than the recording/reproducing wavelength.
<5> The optical recording medium according to <4>, wherein the dye material (A) is a cyanine dye expressed by General Formula (I) shown below:

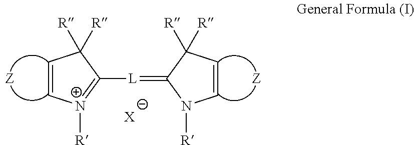

in the formula above, R′ and R″ each independently represents an alkyl group, an aralkyl group, or an aryl group that may be substituted by a substituent, and adjacent R″s may be linked together to form an alicyclic hydrocarbon ring or a heterocyclic ring; Z represents a group of atoms to form an aromatic ring, X represents a monovalent anion, and L represents a connecting group to form a carbocyanine.

<6> The optical recording medium according to <4>, wherein the dye material (B) is a squarylium dye expressed by General Formula (II) below:

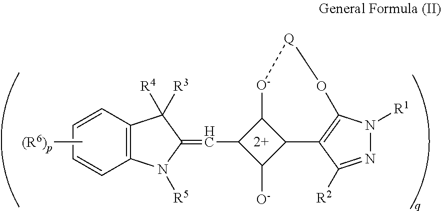

in the formula above, R¹ and R², which may be identical or different, each represent a hydrogen atom, an alkyl group that may have a substituent, an aralkyl group that may have a substituent, an aryl group that may have a substituent, or a heterocyclic group that may have a substituent; Q represents a metal atom capable of coordinating; q is an integer of 2 or 3; R³ and R⁴, which may be identical or different, each represent a hydrogen atom, an alkyl group that may have a substituent, an aralkyl group that may have a substituent, or an aryl group that may have a substituent, and R³ and R⁴ may be linked together to form an alicyclic hydrocarbon ring or a heterocyclic ring; R⁵ represents a hydrogen atom, an alkyl group that may have a substituent, an aralkyl group that may have a substituent, or an aryl group that may have a substituent; R⁶ represents a halogen atom, an alkyl group that may have a substituent, an aralkyl group that may have a substituent, an aryl group that may have a substituent, a nitro group, a cyano group, or an alkoxy group that may have a substituent; p is an integer of 0 to 4, and when p is 2 to 4, R⁶s may be identical or different and two neighboring R⁶ and adjacent two carbon atoms may form in combination an aromatic group that may have a substituent.

<7> The optical recording medium according to any one of <1> to <6>, wherein light absorbance (Abs.) at wavelength 660 nm is larger than light absorbance (Abs.) at wavelength 650 nm in the dye recording layer.
<8> The optical recording medium according to any one of <1> to <7>, wherein reflectance to laser light of wavelength 650 nm is larger than reflectance to laser light of wavelength 660 nm in the dye recording layer.
<9> The optical recording medium according to <1> or <2>, wherein a wavelength-dependent parameter (“n” expressed by the formula below), calculated in the wavelength region of 645 nm to 670 nm, is −25 to +25,

n=(dPw/dλ)/(Pw at 655 nm)/655)

where (dPw/dλ) denotes a change in the value of recording power per 1 nm change in wavelength, and (Pw at 655 nm) is a recording power necessary to record at wavelength 655 nm.

<10> The optical recording medium according to any one of <1> to <9>, comprising a substrate having a surface on which spiral grooves and lands between the grooves are formed, wherein the spiral grooves wobble along a radial direction with a track pitch of 0.74±0.03 μm, at least the dye recording layer and a light reflective layer are laminated in order thereon, and additional information is recorded at the grooves and/or lands.
<11> The optical recording medium according to <10>, wherein the information indicating that reflectance after recording is higher than reflectance before recording is recorded as additional information.
<12> The optical recording medium according to any one of <1> to <11>, wherein the optical recording medium comprises a substrate on which the dye recording layer is formed and has grooves at the surface of the substrate, and groove depth of the grooves is 20 nm to 100 nm.
<13> The optical recording medium according to any one of <1> to <11>, comprising a first information layer having a first recording layer of the dye recording layer and a second information layer having a second recording layer of the dye recording layer in order from incident side of laser light, wherein groove depth of grooves at surface of a first substrate of the first information layer is 20 nm to 100 nm and groove depth at surface of a second substrate of the second information layer is 10 nm to 40 nm, and respective half-value widths of each groove width are 20% to 60% of each track pitch.
<14> The optical recording medium according to any one of <1> to <13>, wherein an access region, other than data regions to be accessed when reproducing, is already recorded.
<15> The optical recording medium according to <14>, wherein the access region comprises a region within an area having a radius of 24 mm.
<16> The optical recording medium according to <15>, wherein the region within an area having a radius of 24 mm comprises a recording region to manage recording that is set in the optical recording medium
<17> An optical recording apparatus, comprising a recording unit configured to record on an optical recording medium, and a distinguishing unit whether or not the optical recording medium, set to the optical recording apparatus, is of low-to-high type in which reflectance at a recording mark portion to laser light is high after recording compared to before recording,

wherein the recording unit makes an access region, other than data regions to be accessed when reproducing, recorded to the optical recording medium when the distinguishing unit distinguishes the optical recording medium as low-to-high type.

<18> A system to prepare a contents-recorded optical recording medium, comprising the optical recording apparatus according to <17>, and a server connected to the optical recording apparatus through network,

wherein the recording unit of the optical recording apparatus makes an access region, other than data regions to be accessed when reproducing, recorded as well as records contents information acquired through the network, when the distinguishing unit distinguishes the optical recording medium as low-to-high type.

### BRIEF DESCRIPTION OF DRAWINGS

FIG. 1 shows a light absorption spectrum of a dye material.

FIG. 2 exemplarily shows a layer configuration of optical recording media of DVD+R or DVD-R.

FIG. 3 exemplarily shows a reverse layer configuration of optical recording media employed in BD-R.

FIG. 4 exemplarily shows a layer configuration of optical recording media comprising a first and a second information layers (in a case of an inverted stack method).

FIG. 5 exemplarily shows a layer configuration of optical recording media comprising a first and a second information layers (in a case of a 2P method).

FIG. 6 exemplarily shows a configuration of optical recording apparatuses.

FIG. 7 shows a light absorption spectrum of the dye used in Examples 1 to 5.

FIG. 8 shows a castle pattern of pulse light emission used in recording in accordance with DVD+R system specifications.

FIG. 9 shows a wave profile (eye pattern) of reproduction signal of the optical recording medium in Example 7.

FIG. 10 shows a light absorption spectrum of the dye used in Examples 10.

FIG. 11 shows light absorption spectra of compounds Nos. 21, 25.

FIG. 12 shows light absorption spectra of compounds Nos. 2, 8, 19, 22, and 24.

FIG. 13 shows light absorption spectra of compounds Nos. 23, 26.

FIG. 14 shows light absorption spectra of compounds Nos. 27, 28.

FIG. 15 shows a wave profile (eye pattern) of reproduction signal of the optical recording medium in Example 11.

FIG. 16 shows a light absorption spectrum of the dye recording layer of the optical recording medium in Examples 19.

FIG. 17 shows the test results of light resistance of the optical recording medium in Examples 26.

FIG. 18 shows the test results of jitter margin to recording power of the optical recording medium in Examples 27.

FIG. 19 shows a wave profile (eye pattern) of reproduction signal of the optical recording medium in Example 32.

FIG. 20 shows jitter variable with recording power of the second dye recording layer in Examples 32 and 38, and Comparative Example 6.

### BEST MODE FOR CARRYING OUT THE INVENTION

The present invention will be explained in detail below.

The invention <1> concerns to an optical recording medium capable of recording in so-called low-to-high mode, in which the reflectance to the laser light at the recording mark portion increases (raises) after recording compared to before recording, using the laser light having a wavelength of 640 nm to 680 nm. The optical recording medium can exhibit a sufficient recording sensitivity (light absorbance) and excellent recording properties at high-speed recording. In addition, the medium of the invention <2>, in which the push-pull signal decreases after recording compared to before recording, can be easily derived and also generation of noises can be prevented that cause due to mixing signals from guide grooves into data signals.

The invention <3> concerns to an optical recording medium capable of recording in low-to-high mode, using the laser light having a wavelength of 400 nm to 410 nm. The push-pull signal decreases after recording compared to before recording, therefore, generation of noises can be prevented that cause due to mixing signals from guide grooves into data signals.

It is preferred in the invention <2> or <3> that the push-pull signal after recording is 0.9 times or less of before recording since the noises of data signals due to mixing signals from guide grooves are more efficiently reduced. It is also more preferable that the push-pull signal is still lower after recording since lower push-pull signal before recording leads to difficult track servo; thus these inventions can efficiently solve such a problem that the track servo is difficult. Furthermore, it is preferred that the push-pull signal is 0.45 or less after recording since the noises of data signals due to mixing signals from guide grooves are still more efficiently reduced.

In the invention <4>, the dye material (A) having a maximum absorption peak wavelength longer than the recording/reproducing wavelength and the dye material (B) having a maximum absorption peak wavelength shorter than the recording/reproducing wavelength are further mixed, thereby, thermal interference between adjacent recording marks, problematic at forming recording marks, can be reduced, recording power margin can be remarkably enhanced, and reflectance can be easily adjusted.

The dye material (A) is an effective material to record in low-to-high mode, and the dye material (B) is also useful for a recording material of conventional high-to-low mode.

The invention <5> defines preferable dye materials (A), and the dye materials can lead to easy adjustment of the light absorption wavelength and excellent recording properties. Furthermore, when at least one of R″s is a benzyl group that may have a substituent or X is PF₆—, it is advantageous in that thermal decomposition temperature of the dye material therein is likely to be suited to record (form) a recording mark portion, the decomposition temperature of the dye material is relatively lower, decomposition speed is relatively higher, and calorific value is likely to be lower. In addition, when L is a pentamethine group, film optical properties are advantageously obtained that are suited to recording at DVD laser wavelength.

The invention <6> defines preferable dye materials (B), and the dye materials can lead to easy adjustment of the light absorption wavelength and excellent recording properties.

In the invention <7>, light absorbance (Abs.) at wavelength 660 nm is larger than light absorbance (Abs.) at wavelength 650 nm (650 nm<660 nm) in the dye recording layer, therefore, the optical recording medium capable of recording in low-to-high mode is preferably easily designed.

In the invention <8>, reflectance to laser light of wavelength 650 nm is larger than reflectance to laser light of wavelength 660 nm (650 nm >660 nm), therefore, the optical recording medium capable of recording in low-to-high mode is preferably easily designed.

Furthermore, laser wavelength of DVDs is typically about 660 nm at recording and about 650 nm at reproducing; in this regard, this invention represents the reflectance to the wavelengths of laser light as 650 nm>660 nm, it is therefore preferred in that the reflectance is obtainable at 650 nm, interchangeability is excellent between light reproducing apparatuses, recording sensitivity is adequate due to obtainable light absorption at 660 nm, and recording properties are excellent at high-speed recording.

In the invention <9>, the wavelength-dependent parameter “n”, defined in DVD+R system specifications described later, is −25 to +25, thereby, the change rate of recording sensitivity necessary for per 1 nm change in wavelength, (dPw/Pw at 655 nm), is less than 3.8% at the wavelength region of 645 nm to 670 nm. Consequently, the change of recording sensitivity is lower in relation to the change of recording wavelength and the interchangeability is preferably excellent between optical recording/reproducing apparatuses.

Furthermore, when the wavelength-dependent parameter “n” is −25 to 0, the recording sensitivity to the laser light of wavelength 670 nm is higher than the recording sensitivity to the laser light of wavelength 645 (645 nm<670 nm), thus optical recording media of low-to-high type can be easily designed. Furthermore, laser wavelength of DVDs is typically about 660 nm at recording and about 650 nm at reproducing; in this regard, this invention represents the recording sensitivity as 650 nm<660 nm, therefore, recording power can be reduced at 660 nm. It is also publicly known that prolonged recording or reproducing on optical discs leads to higher temperatures of optical recording/reproducing apparatuses and the wavelength of laser light emitted from laser diodes comes to longer, thus the recording sensitivity can be maintained adequately against the wavelength fluctuation. That is, stable recording ability can be obtained at the laser wavelengths of 640 to 680 nm that are employed widely in DVD drives.

The method to calculate the wavelength-dependent parameter “n” is introduced from system specifications such as DVD+R 4.7 GBytes Basic Format Specification version 1.3 (hereinafter referred to as “DVD+R system specifications); that is, “n” is calculated on the basis of the following formula.

n=(dPw/dλ)/(Pw at 655 nm)/655)

where (dPw/dλ) denotes a change in recording power per 1 nm change in laser light wavelength, and (Pw at 655 nm) is a laser light power necessary to record information using laser light of wavelength 655 nm.

In the invention <10>, the format of grooves is made into the same as those of currently commercially available DVD+R or DVD-R, thereby additional information such as addresses on groves and recording waveforms can be decoded with the same format as that of conventional recording media of high-to-low type. Therefore, reproduction can be easily carried out. Such additional information can be recorded by use of phase modulation of wobble groove, pits formed at the lands modulated with a certain regulation, amplitude of wobble groove modulated with a certain regulation, etc. The amplitude of wobble groove is about 10 to 60 nm.

In the invention <11>, the fact of an optical recording medium capable of recording in low-to-high mode is recorded as additional information, which can thus be easily determined by the optical recording apparatuses described later.

In the invention <12>, groove depth of the grooves formed at the surface of the substrate is 20 nm to 100 nm, it is therefore preferred that the push-pull signal can be easily reduced after recording compared to before recording and the push-pull signal can be easily obtained in a unrecorded condition necessary for track servo.

In the invention <13>, recording in low-to-high mode can be carried out also in optical recording media having two recording layers by way of selecting the groove depth and the groove width of the first and the second substrates.

In the invention <14>, the region to be accessed when reproducing is made recorded. Thereby, the reflectance of the access region is made equivalent with those of optical recording media of high-to-low type after finishing the recording, and reproduction can be easily carried out by existing DVD reproducing apparatuses.

The access region refers to a recording management and control region (recording region for recording management) that exists within a radius of 24 mm from an initial data region. The recording management and control region is used to adjust recording conditions (e.g. recording power) necessary for recording, to adjust servo or equalizing necessary for reproduction, or to record management information necessary for recording/reproducing.

In addition, when data recording capacity is small (data region is narrow), unrecorded portions remain outside the data region, thus the unrecorded portions may be access regions.

In this regard, these access regions may be additionally altered depending on specifications of respective reproduction drives.

When these access regions are made recorded, all thereof may be made recorded or a part thereof may be made recorded if there are no problems such as inferior servo.

In the invention <15>, a region within an area having a radius of 24 mm is made recorded. Management information is recorded at the region having a radius of 23 to 24 mm at peripheries of media in recorded DVD, therefore, the area near the region is inevitably accessed at reproducing. Then the region within the area having a radius of 24 mm is made recorded, the reflectance is made equivalent with those of optical recording media of high-to-low type, and reproduction can be easily carried out by existing DVD reproducing apparatuses.

In addition, there exists a recording region for recording management within the area having a radius of 24 mm as described above, the region is usually remained to be unrecorded after completing the recording on the media. However, when the recording region for recording management is made recorded as the invention <16>, the reflectance is made equivalent with those of optical recording media of high-to-low type, and reproduction can be easily carried out by existing DVD reproducing apparatuses.

In accordance with the invention <17>, an optical recording apparatus can be provided that makes the access region, other than data regions to be accessed when reproducing, recorded when the optical recording medium is distinguished as low-to-high type.

In accordance with the invention <18>, a contents-recorded optical recording medium can be provided while efficiently incorporating contents information.

### Optical Recording Medium

The inventive optical recording medium contains at least a dye recording layer and also other optional layers selected depending on the application.

### Dye Recording Layer

The dye recording layer is one of the first or the second embodiment described below.

The dye recording layer of the first embodiment may be properly selected from those capable of being recorded at recording mark portions by a recording light having a DVD laser wavelength of 640 to 680 nm, and it is necessary that the dye recording layer can undergo recording of low-to-high mode.

The dye recording layer of the second embodiment may be properly selected from those capable of being recorded at recording mark portions by a recording light having a blue laser wavelength of 400 to 410 nm, and it is necessary that the dye recording layer can undergo recording of low-to-high mode.

When the recording is carried out in low-to-high mode, the optical recording medium may exhibit excellent recording sensitivity or light absorptance and superior recording properties at high-speed recording.

The definitions and measuring methods of push-pull signals, radial contrast signals, differential signals, reflectances, etc. in the present invention are described in system specifications of DVD+R, and the DVD evaluation device (by Pulstec Industrial Co.) in Examples described later is based on the measuring conditions of this system specifications.

It is preferred in the present invention that the dye recording layers of both of the first and the second embodiments satisfy at least one of the properties below.

### Property 1

The push-pull signal decreases after recording, preferably no more than 0.3 after recording.

When the push-pull signal is unduly large, there arises a problem that signals due to guide grooves are intermixed into data signals as noise components.

The inventive optical recording medium, on the contrary, exhibits higher reflectances after recording, thus the push-pull signals can be easily reduced. Therefore, the signals due to guide grooves can be prevented from intermixing into data signals as noise components.

### Property 2

In cases where the optical recording medium is set and the push-pull signal is measured, the optical recording medium is distinguished as read-only when the push-pull signal is within a first range and as rewritable when the push-pull signal is within a second range larger than the first range, then the push-pull signal at the dye recording layer is within the first range after recording.

In this case, the optical recording medium is distinguished as read-only after recording, therefore, the optical recording medium after recording can be advantageously easily reproduced without being recognized as an illegal copy even by use of reproducing apparatuses capable of reproducing optical recording devices that have been recognized as a read-only disc.

The first and the second ranges described above are appropriately adjusted in various reproducing apparatuses, and the optical recording medium can be appropriately selected therefrom. When the first range is “0.45 or less” and the second range is “0.46 or more”, an optical recording medium can be selected that exhibits a push-pull signal of 0.45 or less after recording. In view of the first range in various reproducing apparatuses, it is advantageous that the first range is no more than 0.3 since identification as to whether or not a read-only disc is sure without confusing between the first range and the second range depending on reproducing apparatuses.

The optical recording media described above are useful because far from the following problems.

That is, digital dynamic image can be recorded with high image quality on DVD for long time, thus copyright protection of the contents is absolutely necessary. A conventional manner to protect copyright is a content scramble system (CSS), for example, which prevents illegal copies available from civilian instruments by general users or illegal copies available from computers. DVD video contents encrypted by CSS are treated as legal merely in read-only DVD discs. As such, when reproducing apparatuses distinguish between recordable DVD discs and read-only DVD discs to determine as a recordable DVD disc, the reproduction of CSS contents recorded in the recordable DVD disc can be inhibited by reason of an illegal copy. The recordable DVD discs and the read-only DVD discs are distinguished on the basis of magnitude of push-pull signals. The read-only DVD discs represent lower push-pull signals compared to those of the recordable DVD discs having guide grooves since no guide grooves exist at substrates. Therefore, when the detected push-pull signals are lower than a pre-determined value, the reproducing apparatuses distinguish to be a read-only DVD disc, and when the detected push-pull signals are higher than a pre-determined value, the reproducing apparatuses determine to be a recordable DVD disc.

On the other hand, such type of business is envisaged recently in which video contents distributed through internet are recorded on recordable DVD discs, supplied from delivery traders, at rental video shops, which are then rent to customer.

However, in recordable DVD discs after recording, there is such a problem that the reproduction is inhibited (consumers cannot see or listen) by reason of illegal copy due to the recordable DVD discs when customers try to reproduce in reproducing apparatuses at home in spite of non-illegal copy.

### Property 3

The push-pull signal at recording mark portions of the dye recording layer decreases to 0.9 times or less after recording compared with before recording, more preferably 0.75 times or less.

When 0.9 times or less, the effect to reduce the signal noise due to the guide grooves is significant and tracking servo can be easily carried out, and when 0.75 times or less, these effects are advantageously more significant.

### Property 4

The value of the push-pull signal at the dye recording layer is no more than 0.45 after recording, and more preferably no more than 0.3.

When the value of the push-pull signal is above 0.45, the effect to reduce the signal noise due to the guide grooves is likely to be insignificant, on the other hand, when the value is 0.45 or less, the effect to reduce the signal noise due to the guide grooves is advantageously significant, and when the value is 0.3 or less in particular, the effect to reduce the signal noise due to the guide grooves is attained to a level of ROMs, thus optical recording media recorded with contents information is enhanced with respect to reproduction compatibility.

Property 5

The reflectance at unrecorded portions of the dye recording layer is 12% or higher, more preferably 16% or higher.

When the reflectance is below 12%, the tracking servo is unobtainable, the optical recording medium is likely to be rejected from the system specifications such as of DVD+R and DVD-R, and adjustment of recording/reproducing conditions is difficult in existing drives; on the other hand, when the reflectance is 12% or higher, tracking servo can be easily carried out, the optical recording medium can pass the system specifications such as of DVD+R and DVD-R, and recording/reproducing conditions can be easily adjusted in existing drives, and when the reflectance is 16% or higher, these effects are advantageously more significant.

### Property 6

Signal-modulation degree at the recording mark portions of the dye recording layer is 40% or high after recording, more preferably 45% or higher.

When the signal-modulation degree is below 40% after recording, reproduction S/N of recording signals is hardly obtainable, the optical recording medium is likely to be rejected from the system specifications such as of DVD+R and DVD-R, and adjustment of recording/reproducing conditions is difficult in existing drives, on the other hand, when 40% or high after recording, reproduction S/N of recording signals is easily obtainable, the optical recording medium can pass the system specifications such as of DVD+R and DVD-R, and adjustment of recording/reproducing conditions is advantageously easy in existing drives, and when 45% or higher, these effects are advantageously more significant.

### Property 7

Light absorptance (Abs.) of the dye recording layer is 0.2 to 0.8 at recording/reproducing wavelength, more preferably 0.3 to 0.5.

When the light absorptance (Abs.) is less than 0.2, as conventional optical recording media of high-to-low mode such as DVD+R and DVD-R, sensitivity and/or signal-modulation degree necessary for recording is hardly obtainable; and when above 0.8, reflectance necessary for optical recording/reproducing is hardly obtainable. On the other hand, when the light absorptance is 0.2 to 0.8, reflectance necessary for optical recording/reproducing is easily obtainable, sensitivity and/or signal-modulation degree necessary for recording is advantageously easily obtainable, and when the light absorptance is within a range of 0.3 to 0.5, these effects are favorably more significant.

### Property 8

A value of radial contrast (RCa) is lower than 0 at recording mark portions of the dye recording layer, more preferably −0.05 or lower.

RCa=(reflective level at land portion−reflective level at groove portion)/(reflective level at land portion)

RCa is higher than 0 in optical recording media of high-to-low type, therefore, RCa of lower than 0 allows to recognize as a low-to-high recording medium. A signal intensity of −0.05 or lower allows more easily to distinguish on the basis of RCa. Furthermore, recognition of optical recording media on the basis of RCa allows to adjust servo depending on optical recording media, leading to easy recording/reproducing.

### Dye Material

It is preferred that the dye recording layer contains one or more dye materials (A) that have a maximum absorption peak wavelength longer than the recording/reproducing wavelength and one or more dye materials (B) that have a maximum absorption peak wavelength shorter than the recording/reproducing wavelength. The content ratio of (B)/((A)+(B)) is preferably 0.1 to 0.9 by mass, more preferably 0.2 to 0.6. When the content ratio is lower than 0.1, the effects to improve recording properties, in particular margin to recording power, and reflectance are hardly obtainable; and when the content ratio is above 0.9, recording sensitivity and signal modulation are hardly obtainable.

In contrast, when the content ratio is 0.1 to 0.9, the reflectance necessary for optical recording/reproducing is easily obtainable, and also sensitivity, signal-modulation degree, and recording power margin necessary for recording are easily obtainable, and when the content ratio is 0.2 to 0.6, these effects are advantageously more significant.

The dye recording is employed from those capable of designing as dye recording layers of the first or the second embodiment.

In the inventive media, which being characterized in the low-to-high recording mode, the main recording material is the dye material (A). It is necessary that the dye material (A) has a light absorbing property in DVD laser wavelengths, and the preferable range of the maximum absorption peak wavelength is 640 to 760 nm.

On the other hand, the dye material (B) has a light absorbing property that is less than that of the dye material (A) in DVD laser wavelengths, and the preferable range of the maximum absorption peak wavelength is in a range of 560 to 640 nm.

The difference between the maximum absorption peak wavelengths of the dye materials (A) and (B) is preferably 40 nm or higher, more preferably 100 nm or higher. When the difference between the maximum absorption peak wavelengths is lower than 40 nm, the modulation degree is hardly obtainable since the high-to-low and low-to-high properties are cancelled.

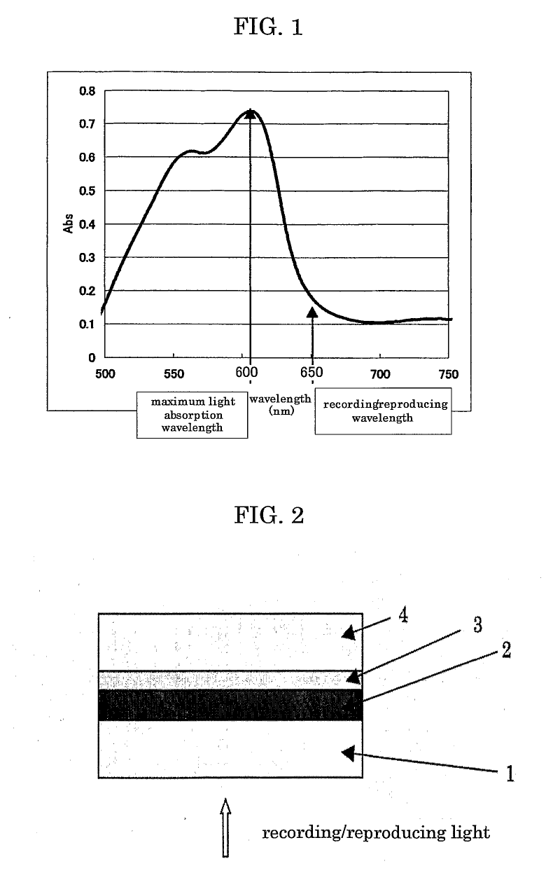

In addition, there exist two peaks in the light absorption spectrum of dye film as shown in FIG. 1. The peak at longer wavelength is usually the maximum light absorption peak, and the peak at shorter wavelength is the maximum light absorption peak in some cases. When the maximum light absorption peak of the dye material (A) is at shorter wavelength and the maximum light absorption peak of the dye material (B) is at longer wavelength, the difference between the maximum light absorption peaks is relatively small, on the other hand, when the maximum light absorption peak of the dye material (A) is at longer wavelength and the maximum light absorption peak of the dye material (B) is at shorter wavelength, the difference between the maximum light absorption peaks is relatively large.

These maximum light absorption peak wavelengths can be determined in spectra of solution that dissolves a dye in a solvent; in particular, the difference between the maximum light absorption peak wavelengths can be easily determined in spectra of solution.

Examples of the dye materials include cyanine dyes, azo dyes, phthalocyanine dyes, and squarylium dyes. These may be used alone or in combination of two or more. It is preferred that these dye materials have a substituent group so as to easily adjust the light absorption wavelength and to easily represent a heat-decomposition property suited to optical recording (e.g. 150° C. to 250° C.).

The cyanine dye may be properly selected depending on the purpose; examples thereof include the compounds illustrated in JP-B Nos. 3834053, 2594443, 3698708, and 3659922, and JP-A No. 2005-205874.

The azo dye may be properly selected depending on the purpose; examples thereof include the compounds illustrated in JP-B Nos. 3834053, 3783722, and 2870952.

The phthalocyanine dye may be properly selected depending on the purpose; examples thereof include the compounds illustrated in Japanese Patent Application Publication (JP-B) Nos. 07-56019 and 07-116371, and JP-B No. 3836192.

The squarylium dye may be properly selected depending on the purpose; examples thereof include the compounds illustrated in JP-A No. 2002-552074 and 2001-544855.

Among these dye materials, the cyanine dyes, expressed by General Formula (I) shown below, are preferable in the present invention in view of ability to easily adjust the light absorption wavelength and excellent recording properties. The cyanine dyes may have a configuration of dimer that is formed through a group connecting the compounds expressed by General Formula (I). Details thereof are described in WO06/123807 pamphlet.

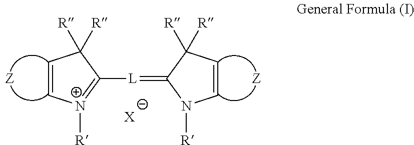

In the formula above, R′ and R″ each independently represents an alkyl group, an aralkyl group, or an aryl group that may be substituted by a substituent, and adjacent R″s may be linked together to form an alicyclic hydrocarbon ring or a heterocyclic ring. At least one of R″s is preferably a benzyl group that may have a substituent; in such cases, it is advantageous in that thermal decomposition temperature of the dye material is suited to form recording mark portions and it is also advantageous in that decomposition temperature of the dye material is likely to be low, decomposing velocity is likely to be high, and calorific value is likely to be small.

Z represents a group of atoms to form an aromatic ring.

X represents a monovalent anion and is preferably PF₆—. When X is PF₆—, it is advantageous in that thermal decomposition temperature of the dye material is suited to form recording mark portions and it is also advantageous in that decomposition temperature of the dye material is likely to be low, decomposing velocity is likely to be high, and calorific value is likely to be small.

L represents a connecting group to form a carbocyanine. The dye material (A) adapted to DVD laser wavelength of 640 to 680 nm is one of which L is a pentamethine group of 5 carbon atoms, and the dye material (B) is preferably a trimethine group of 3 carbon atoms. The dye materials (A) and (B) adapted to blue laser wavelength are one of which L is a monomethine group of one carbon atom. As such, it is advantageous in that optical properties of film are adaptable to the wavelength of recording light depending on the carbon number of L.

The dye material (B), adapted to DVD laser wavelength of 640 to 680 nm, is preferably the squarylium dyes expressed by General Formula (II) below.

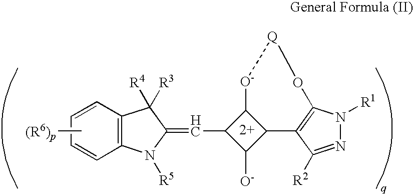

In the formula above, R¹ and R², which may be identical or different, each represent a hydrogen atom, an alkyl group that may have a substituent, an aralkyl group that may have a substituent, or a heterocyclic group that may have a substituent; Q represents a metal atom capable of coordinating; q is an integer of 2 or 3; R³ and R⁴, which may be identical or different, each represent a hydrogen atom, an alkyl group that may have a substituent, an aralkyl group that may have a substituent, or an aryl group that may have a substituent, and R³ and R⁴ may be linked together to form an alicyclic hydrocarbon ring or a heterocyclic ring; R⁵ represents a hydrogen atom, an alkyl group that may have a substituent, an aralkyl group that may have a substituent, or an aryl group that may have a substituent; R⁶ represents a halogen atom, an alkyl group that may have a substituent, an aralkyl group that may have a substituent, an aryl group that may have a substituent, a nitro group, a cyano group, or an alkoxy group that may have a substituent, p is an integer of 0 to 4, and when p is 2 to 4, R⁶s may be identical or different and two neighboring R⁶ and adjacent two carbon atoms may form in combination an aromatic group that may have a substituent.

Furthermore, R¹ is preferably a phenyl group. R² is preferably a halogen-substituted or unsubstituted alkyl group or an alkyl group with a branched chain, more preferably a trifluoromethyl group or an isopropyl group. R³ and R⁴ are each preferably an unsubstituted aryl group, more preferably a benzyl group. R⁶ is preferably a naphthyl group formed with a benzene ring.

The alkyl moiety of the alkyl and alkoxy groups in the definition of the substituent groups of General Formula (II) is exemplified by linear or branched alkyl groups of 1 to 6 carbon atoms or cyclic alkyl groups of 3 to 8 carbon atoms; specific examples thereof include methyl group, ethyl group, propyl group, isopropyl group, butyl group, isobutyl group, sec-butyl group, tert-butyl group, pentyl group, isopentyl group, 1-methylbutyl group, 2-methylbutyl group, tert-pentyl group, hexyl group, cyclopropyl group, cyclobutyl group, cyclopentyl group, cyclohexyl group, cycloheptyl group, and cyclooctyl group.

The aralkyl group is preferably those of 7 to 19 carbon atoms, more preferably those of 7 to 15 carbon atoms; examples thereof include benzyl group, phenethyl group, phenylpropyl group, and naphthylmethyl group.

The aryl group is preferably those of 6 to 18 carbon atoms, more preferably those of 6 to 14 carbon atoms; examples thereof include phenyl group, naphthyl group, anthryl group, and azulenyl group.

The halogen atom is exemplified by chlorine, bromine, fluorine, and iodine atoms.

Examples of the metal atom Q capable of coordinating include aluminum, zinc, copper, iron, nickel, chromium, cobalt, manganese, iridium, vanadium, and titanium. The squarylium dye, of which Q is aluminum to form a complex, can provide the inventive optical recording medium with excellent optical properties.

The aromatic ring, which being formed from two neighboring R⁶ and adjacent two carbon atoms, is preferably those of 6 to 14 carbon atoms; examples thereof include benzene ring and naphthalene ring.

Heterocyclic rings of the heterocyclic group are exemplified by five-membered or six-membered monocyclic aromatic or alicyclic heterocyclic rings containing at least one atom selected from nitrogen, oxygen, and sulfur; and bicyclic or tricyclic condensed aromatic or alicyclic heterocyclic rings, formed by condensing three-membered to eight-membered rings, containing at least one atom selected from nitrogen, oxygen, and sulfur; specific examples thereof include pyridine ring, pyrazine ring, pyrimidine ring, pyridazine ring, quinoline ring, isoquinoline ring, phthalazine ring, quinazoline ring, quinoxaline ring, naphthyridine ring, cinnoline ring, pyrrole ring, pyrazole ring, imidazole ring, triazole ring, tetrazole ring, thiophene ring, furan ring, thiazole ring, oxazole ring, indole ring, isoindole ring, indazole ring, benzimidazole ring, benzotriazole ring, benzothiazole ring, benzoxazole ring, purine ring, carbazole ring, pyrrolidine ring, piperidine ring, piperazine ring, morpholine ring, thiomorpholine ring, homopiperidine ring, homopiperazine ring, tetrahydropyridine ring, tetrahydroquinoline ring, tetrahydroisoquinoline ring, tetrahydrofurane ring, tetrahydropyrane ring, dihydrobenzofurane, and tetrahydrocarbazole ring.

The substituent of the aralkyl groups, aryl groups, alkoxy groups, heterocyclic groups, and aromatic rings formed from two neighboring R⁶ and adjacent two carbon atoms is exemplified by 1 to 5 substituents that may be identical or different, more specifically by hydroxyl group, carboxyl group, halogen atoms, substituted or unsubstituted alkyl groups, alkoxy groups, nitro group, and substituted or unsubstituted amino groups. Specific examples of the halogen atoms, alkyl groups, and alkoxy groups are similar to those described above.

The substituent of the alkyl groups is exemplified by 1 to 3 substituents that may be identical or different, more specifically by hydroxyl group, carboxyl group, halogen atoms, and alkoxy groups. Specific examples of the halogen atoms and alkoxy groups are similar to those described above.

The substituent of the amino groups is exemplified by 1 to 2 alkyl groups that may be identical or different; specific examples of the alkyl groups are similar to those described above.

The squarylium dyes expressed by General Formula (II) can be prepared in accordance with the method described in WO02/50190 pamphlet.

Specific examples of the squarylium dyes are shown in Table 1, in which Ph is a phenyl group, CF₃ is a trifluoromethyl group, CH₃ is a methyl group, t-Bu is a tert-butyl group, i-Pr is an isopropyl group, and cyclohexyl represents a six-membered ring that is formed by bonding R³ and R⁴ together.

The site of the substituent of R⁶ is the same as that of No. 1 described later in terms of naphthyl and the same as that of No. 8 described later in terms of CH₃.

TABLE 1

| | Structure of Dye | | | | | | | |
|---|---|---|---|---|---|---|---|---|
| No. | R¹ | R² | R³ | R⁴ | R⁵ | R⁶ | Q | q |
| No. 1 | Ph | CF₃ | CH₃ | CH₃ | CH₃ | naphthyl | Al | 3 |
| No. 2 | Ph | CF₃ | CH₃ | CH₃ | benzyl | CH₃ | Al | 3 |
| No. 3 | t-Bu | CF₃ | CH₃ | CH₃ | CH₃ | H | Al | 3 |
| No. 4 | Ph | i-Pr | CH₃ | CH₃ | CH₃ | H | Al | 3 |
| No. 5 | Ph | CF₃ | CH₃ | H | C₂H₅ | OCH₃ | Al | 3 |
| No. 6 | Ph | CF₃ | cyclohexyl | | CH₃ | naphthyl | Al | 3 |
| No. 7 | Ph | CF₃ | CH₃ | benzyl | CH₃ | H | Al | 3 |
| No. 8 | Ph | CF₃ | benzyl | benzyl | C₂H₅ | CH₃ | Al | 3 |
| No. 9 | Ph | CF₃ | benzyl | CH₃ | C₂H₅ | naphthyl | Al | 3 |
| No. 10 | Ph | CF₃ | benzyl | benzyl | benzyl | H | Al | 3 |
| No. 11 | Ph | CF₃ | CH₃ | benzyl | CH₃ | naphthyl | Al | 3 |

Structural formulas of the squarylium dyes of Nos. 1, 8, and 11 in Table 1 are shown below.

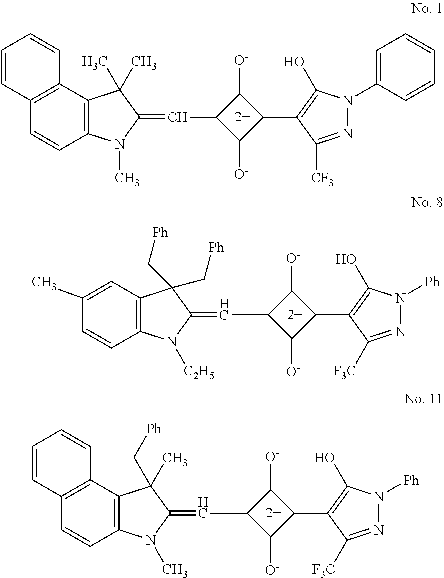

The dye recording layer in the present invention may be included other ingredients as required in addition to the dye material in order to enhance light resistance, to improve optical properties, or to upgrade temperature resistance and/or humidity resistance.

As for the materials of these purposes concerning a light resistance improver, it is preferable to include (C) a light resistant material that has a maximum absorption peak wavelength longer than the recording/reproducing wavelength or (D) a light resistant material that has a maximum absorption peak wavelength shorter than the recording/reproducing wavelength. It is also preferred that one species of the light resistant material (C) and one species of the light resistant material (D) are included at the same time.

The reason is that the light resistant material (C) effectively affects the dye material (A) and the light resistant material (D) effectively affects the dye material (B) because of close light absorption wavelengths.

Examples of the light resistant material include pyrylium/thiopyrylium dyes, azulenium dyes, formazan chelate complexes, azo metal complexes, dithiol metal complexes, metal complex salt dyes such as of Ni and Cr, naphthoquinone/anthraquinone dyes, indophenol dyes, indoaniline dyes, triphenylmethane dyes, triallylmethane dyes, aluminum/diimmonium dyes, and nitroso compounds. It is preferred that these dye materials have a substituent since the light absorption wavelength can be easily adjusted and also thermal decomposition properties may be adjusted for optical recording, in which the light resistant material does not concern directly to recording thus the thermal decomposition temperature may be higher than that of dyes in the dye recording layer e.g. 150° C. to 300° C.

Preferably, the light resistance improver of the dye material (A) suited to the DVD laser wavelength of 640 nm to 680 nm is dithiol metal complexes or and aluminum/diimmonium dyes and the light resistance improver of the dye material (B) suited to the DVD laser wavelength of 640 to 680 nm is azo metal complexes. Preferably, the light resistance improver of the dye materials (A) and (B) suited to blue laser wavelength is azo metal complexes.

The dithiol metal complex may be properly selected depending on the application and is exemplified by those described in JP-B No. 3020256 or “Nippon Kagaku Kaishi, 1992, vol. 10, pp. 1141-1143”.

The aluminum/diimmonium dye may be properly selected depending on the application and is exemplified by those described in JP-B Nos. 06-26028, 3097628, 3781283, 3871282, etc.

The formazan chelate complex may be properly selected depending on the application and is exemplified by those described in JP-B No. 3456621, JP-A Nos. 2001-23235 and 2002-293027, WO00/075111 pamphlet, and JP-B No. 2791944.

The azo metal complex may be properly selected depending on the application and is exemplified by those described in JP-A Nos. 2002-201373 and 2005-205874.

It is preferred in order to enhance storage stability by including the compound, in which a formazan compound expressed by General Formula (III) or (IV) below and a metal form a complex, as the formazan chelate complex.

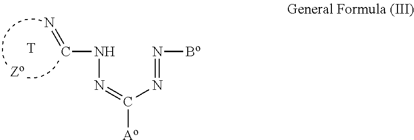

In the formula above, the ring T represents a substituted or unsubstituted five-membered or six-membered ring having a nitrogen atom; Z⁰ represents an atomic group to form the ring T; another ring may condense with the heterocyclic ring that contains the nitrogen ring; A⁰ represents an alkyl group that may have a substituent, an aryl group that may have a substituent, an alkylcarbonyl group that may have a substituent, an arylcarbonyl group that may have a substituent, an alkenyl group that may have a substituent, a heterocyclic residual group that may have a substituent, or an alkyloxycarbonyl group that may have a substituent; and B⁰ represents an alkyl group that may have a substituent, an alkenyl group that may have a substituent, or an aryl group that may have a substituent.

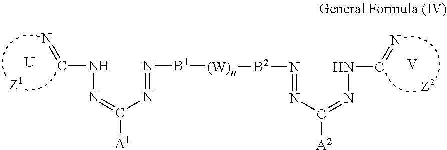

In the formula above, the rings U and V, which may be identical or different, each represent a substituted or unsubstituted five-membered or six-membered ring having a nitrogen atom; Z¹ and Z² represent atomic groups to form the rings U and V respectively; another ring may condense with the heterocyclic ring that contains the nitrogen ring; A¹ and A² each represent an alkyl group that may have a substituent, an aryl group that may have a substituent, an alkylcarbonyl group that may have a substituent, an arylcarbonyl group that may have a substituent, an alkenyl group that may have a substituent, a heterocyclic residual group that may have a substituent, or an alkyloxycarbonyl group that may have a substituent; B¹ and B² each represent an alkylene group that may have a substituent, an alkenylene group that may have a substituent, or an arylene group that may have a substituent; W represents —CH₂— or —SO₂—; n is 0 or 1.

The rings T, U, and V each may have another ring D that bonds thereto. The ring D may be a heterocyclic ring in addition to carbon rings. In cases of carbon rings, the ring has preferably 6 to 20 carbon atoms, more preferably 6 to 10 carbon atoms; specific examples thereof are a benzene ring, naphthalene ring, cyclohexane ring, etc. In cases of heterocyclic rings, the ring has preferably 5 to 20 atoms, more preferably 5 to 14 atoms; specific examples thereof are a pyrrolidine ring, thiazole ring, imidazole ring, thiadiazole ring, oxazole ring, triazole ring, pyrazole ring, oxadiazole ring, pyridine ring, pyridazine ring, pyrimidine ring, pyrazine ring, triazine ring, quinoline ring, indoline ring, carbazole ring, etc.

Specific examples of substituents that bond to the T, U, or V ring are each independently halogen atoms, a nitro group, cyano group, carboxyl group, amino group, carbamoyl group, an alkyl group that may have a substituent, an aryl group that may have a substituent, a heterocyclic group that may have a substituent, an alkoxy group that may have a substituent, an aryloxy group that may have a substituent, an alkylthio group that may have a substituent, an arylthio group that may have a substituent, an alkylamino group that may have a substituent, an arylamino group that may have a substituent, an alkoxycarbonyl group that may have a substituent, an aryloxycarbonyl group that may have a substituent, an alkylcarboxamide group that may have a substituent, an arylcarboxamide group that may have a substituent, an alkylcarbamoyl group that may have a substituent, an arylcarbamoyl group that may have a substituent, an alkenyl group that may have a substituent, and an alkylsulfamoyl group that may have a substituent.

In General Formulas (III) and (IV), A⁰, A¹, and A² each represent an alkyl group that may have a substituent, an aryl group that may have a substituent, an alkylcarbonyl group that may have a substituent, an arylcarbonyl group that may have a substituent, an alkenyl group that may have a substituent, a heterocyclic group that may have a substituent, or an alkoxycarbonyl group that may have a substituent. The alkyl or the alkenyl groups may be of chain or ring. Carbon number of the alkyl groups is preferably 1 to 15, more preferably 1 to 8; carbon number of the alkenyl groups is preferably 2 to 8, more preferably 2 to 6.

In General Formula (III), B⁰ represents an alkyl group that may have a substituent, an alkenyl group that may have a substituent, or an aryl group that may have a substituent. The alkyl or the alkenyl groups may be of chain or ring. Carbon number of the alkyl groups is preferably 1 to 15, more preferably 1 to 8; carbon number of the alkenyl groups is preferably 2 to 8, more preferably 2 to 6; and carbon number of the aryl groups is preferably 6 to 18, more preferably 6 to 14.

In General Formula (IV) shown above, B¹ and B² each represent an alkylene group that may have a substituent, an alkenylene group that may have a substituent, or an arylene group that may have a substituent. The alkylene or the alkenylene groups may be of chain or ring. Carbon number of the alkylene groups is preferably 1 to 15, more preferably 1 to 8; carbon number of the alkenylene groups is preferably 2 to 8, more preferably 2 to 6; and carbon number of the arylene groups is preferably 6 to 18, more preferably 6 to 14.

In General Formulas (III) and (IV), examples of the alkyl groups include straight chain alkyl groups such as methyl, ethyl, n-propyl, n-butyl, n-pentyl, n-hexyl, n-heptyl, n-octyl, n-nonyl, and n-decyl groups; branched alkyl groups such as isobutyl, isoamyl, 2-methylbutyl, 2-methylpentyl, 3-methylpentyl, 4-methylpentyl, 2-ethylbutyl, 2-methylhexyl, 3-methylhexyl, 4-methylhexyl, 5-methylhexyl, 2-ethylpentyl, 3-ethylpentyl, 2-methylheptyl, 3-methylheptyl, 4-methylheptyl, 5-methylheptyl, 2-ethylhexyl, 3-ethylhexyl, isopropyl, sec-butyl, 1-ethylpropyl, 1-methylbutyl, 1,2-dimethylpropyl, 1-methylheptyl, 1-ethylbutyl, 1,3-dimethylbutyl, 1,2-dimethylbutyl, 1-ethyl-2-methylpropyl, 1-methylhexyl, 1-ethylheptyl, 1-propylbutyl, 1-isopropyl-2-methylpropyl, 1-ethyl-2-methylbutyl, 1-propyl-2-methylpropyl, 1-methylheptyl, 1-ethylhexyl, 1-propylpentyl, 1-isopropylpentyl, 1-isopropyl-2-methylbutyl, 1-isopropyl-3-methylbutyl, 1-methyloctyl, 1-ethylheptyl, 1-propylhexyl, 1-isobutyl-3-methylbutyl, neopentyl, tert-butyl, tert-hexyl, tert-amyl, and tert-octyl groups; and cycloalkyl groups such as cyclohexyl, 4-methylcyclohexyl, 4-ethylcyclohexyl, 4-tert-butylcyclohexyl, 4-(2-ethylhexyl)cyclohexyl, bornyl, isobornyl, and adamantly groups; among these, those having 1 to 8 carbon atoms are preferable.

These alkyl groups may be substituted by a substituent such as a hydroxyl group, halogen atoms, nitro group, carboxyl group, and cyano group or may be substituted by aryl or heterocyclic groups that may have a specific substituent such as halogen atoms or nitro group, and also may be substituted by another hydrocarbon group described above etc. through hetero atoms such as oxygen, sulfur, and nitrogen atoms.

Examples of the alkyl group substituted by another hydrocarbon group through an oxygen atom include alkyl groups substituted by alkoxy or aryloxy groups such as a methoxymethyl group, methoxyethyl group, ethoxymethyl group, ethoxyethyl group, butoxyethyl group, ethoxyethoxyethyl group, phenoxyethyl group, methoxypropyl group, and ethoxypropyl group. These alkoxy or aryloxy groups may be further substituted by a substituent.

Examples of the alkyl group substituted by another hydrocarbon group through a sulfur atom include alkyl groups substituted by alkylthio or arylthio groups such as a methylthioethyl group, ethylthioethyl group, ethylthiopropyl group, and phenylthioethyl group. These alkylthio or arylthio groups may be further substituted by a substituent.

Examples of the alkyl group substituted by another hydrocarbon group through a nitrogen atom include alkyl groups substituted by alkylamino or arylamino groups such as a dimethylaminoethyl group, diethylaminoethyl group, diethylaminopropyl group, and phenylaminomethyl group. These alkylamino or arylamino groups may be further substituted by a substituent.

The alkenyl groups in General Formulas (III) and (IV) are preferably those having 2 to 6 carbon atoms; examples thereof include a vinyl group, allyl group, 1-propenyl group, methacrylic group, chlothyl group, 1-butenyl group, 3-butenyl group, 2-pentenyl group, 4-pentenyl group, 2-hexenyl group, 5-hexenyl group, 2-heptenyl group, and 2-octenyl group. Substituents of the alkenyl groups may be similar to those of the alkyl groups described above.

Specific examples of the aryl groups in General Formulas (III) and (IV) are a phenyl group, naphthyl group, anthranil group, fluorenyl group, phenalenyl group, phenanthranyl group, triphenylenyl group, pylenyl group.

The alkylene and alkenylene groups in General Formulas (III) and (IV) may be the above-noted alkyl and alkenyl groups from which one hydrogen atom is removed.

The arylene groups in General Formulas (III) and (IV) may be the above-noted aryl groups from which one hydrogen atom is removed.

The aryl and arylene groups in General Formulas (III) and (IV) may be substituted by alkyl groups, alkenyl groups, hydroxyl group, halogen atoms, nitro group, carboxyl group, cyano group, trifluoromethyl group, aryl groups that may have a specific substituent such as halogen atoms and nitro group, or heterocyclic groups that may have a specific substituent such as halogen atoms and nitro group. The alkyl, alkenyl, and aryl groups may be similar to those described above; the halogen atoms may be fluorine, chlorine, bromine, or iodine atom.

Specific examples of the heterocyclic groups in General Formulas (III) and (IV) include a furyl group, thienyl group, pyrrolyl group, benzofuranyl group, isobenzofuranyl group, benzothienyl group, indolinyl group, isoindolinyl group, carbazolyl group, pyridyl group, piperidyl group, quinolyl group, isoquinolyl group, oxazolyl group, isoxazolyl group, thiazolyl group, isothiazolyl group, imidazolyl group, pyrazolyl group, benzimidazolyl group, pyrazyl group, pyrimidinyl group, pyridazinyl group, and quinoxalinyl group.

These heterocyclic groups may be substituted by a hydroxyl group, alkyl groups, halogen atoms, a nitro group, carboxyl group, cyano group, aryl groups that may have a specific substituent such as halogen atoms or nitro group, or heterocyclic groups that may have a specific substituent such as halogen atoms or nitro group, and also may be substituted by a hydrocarbon group such as alkyl groups described above etc. through hetero atoms such as oxygen, sulfur, and nitrogen atoms. The alkyl, alkenyl, and aryl groups and the halogen atoms may be similar to those described above.

The alkoxy groups, which may have a substituent, may be those having an alkyl group, which may have a substituent, directly bonded to an oxygen atom. Specific examples of the alkyl group and substituents are similar to those described above.

The aryloxy group, which may have a substituent, may be those having an aryl group, which may have a substituent, directly bonded to an oxygen atom. Specific examples of the aryl group and substituents are similar to those described above.

The alkylthio group, which may have a substituent, may be those having an alkyl group, which may have a substituent, directly bonded to a sulfur atom. Specific examples of the alkyl group and substituents are similar to those described above.

The arylthio group, which may have a substituent, may be those having an aryl group, which may have a substituent, directly bonded to a sulfur atom. Specific examples of the aryl group and substituents are similar to those described above.

The alkylamino group, which may have a substituent, may be those having an alkyl group, which may have a substituent, directly bonded to a nitrogen atom. Specific examples of the alkyl group and substituents are similar to those described above. In addition, alkyl groups themselves may be bonded with an oxygen atom, nitrogen atom, etc. to form rings such as of piperidino group, morpholino group, pyrrolidinyl group, piperazinyl group, indolinyl group, and isoindolinyl group.

The arylamino group, which may have a substituent, may be those having an aryl group, which may have a substituent, directly bonded to a nitrogen atom. Specific examples of the aryl group and substituents are similar to those described above.

The alkylcarbonyl group, which may have a substituent, may be those having an alkyl group, which may have a substituent, directly bonded to a carbon atom of a carbonyl group. Specific examples of the alkyl group and substituents are similar to those described above.

The arylcarbonyl group, which may have a substituent, may be those having an aryl group, which may have a substituent, directly bonded to a carbon atom of a carbonyl group. Specific examples of the aryl group and substituents are similar to those described above.

The alkoxycarbonyl group, which may have a substituent, may be those having an alkyl group, which may have a substituent, directly bonded to an oxygen atom. Specific examples of the alkyl group and substituents are similar to those described above.

The aryloxycarbonyl group, which may have a substituent, may be those having an aryl group, which may have a substituent, directly bonded to an oxygen atom. Specific examples of the aryl group and substituents are similar to those described above.

The alkylcarboxamide group, which may have a substituent, may be those having an alkyl group, which may have a substituent, directly bonded to a carbon atom of a carboxamide. Specific examples of the alkyl group and substituents are similar to those described above.

The arylcarboxamide group, which may have a substituent, may be those having an aryl group, which may have a substituent, directly bonded to a carbon atom of a carboxamide. Specific examples of the aryl group and substituents are similar to those described above.

The alkylcarbamoyl group, which may have a substituent, may be those having an alkyl group, which may have a substituent, directly bonded to a nitrogen atom of a carbamoyl group. Specific examples of the alkyl group and substituents are similar to those described above. In addition, alkyl groups themselves may be bonded with an oxygen atom, nitrogen atom, etc. to form rings such as of piperidino group, morpholino group, pyrrolidinyl group, piperazinyl group, indolinyl group, and isoindolinyl group.

The arylcarbamoyl group, which may have a substituent, may be those having an aryl group, which may have a substituent, directly bonded to a nitrogen atom of a carbamoyl group. Specific examples of the aryl group and substituents are similar to those described above.

The alkylsulfamoyl group, which may have a substituent, may be those having an alkyl group, which may have a substituent, directly bonded to a nitrogen atom of a sulfamoyl group. Specific examples of the alkyl group and substituents are similar to those described above.

The metal constituent in the formazan chelate complex may be any metals or metal compounds that can form a chelate in the formazan; examples of the metal constituent include titanium, vanadium, chromium, manganese, iron, cobalt, nickel, copper, zinc, zirconium, niobium, molybdenum, technetium, ruthenium, rhodium, palladium, oxides thereof, halides thereof, etc. The metal constituent is preferably vanadium, manganese, iron, cobalt, nickel, copper, zinc, or palladium in particular; the inventive optical recording media, which employ a formazan metal chelate compound of these metals, may exhibit excellent optical properties. Among halides, chlorides are favorably employed.

The dithiol metal complex is preferably complex compounds, expressed by General Formula (V) below, formed from a dithiol compound and a metal M in view of superior storage stability.

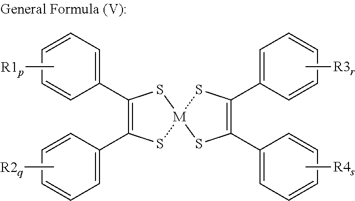

In the formula above, R1, R2, R3, and R4, which may be identical or different, represent an alkyl group that may have a substituent, an alkoxy group that may have a substituent, an aryl group that may have a substituent, a heterocyclic group that may have a substituent, halogen atoms, a nitro group, cyano group, or hydrogen atom; p, q, r, and s each independently represents an integer of 0 to 4; M represents Ni or Cu.

Layer configuration available in the inventive optical recording media will be explained with reference to figures in the following.

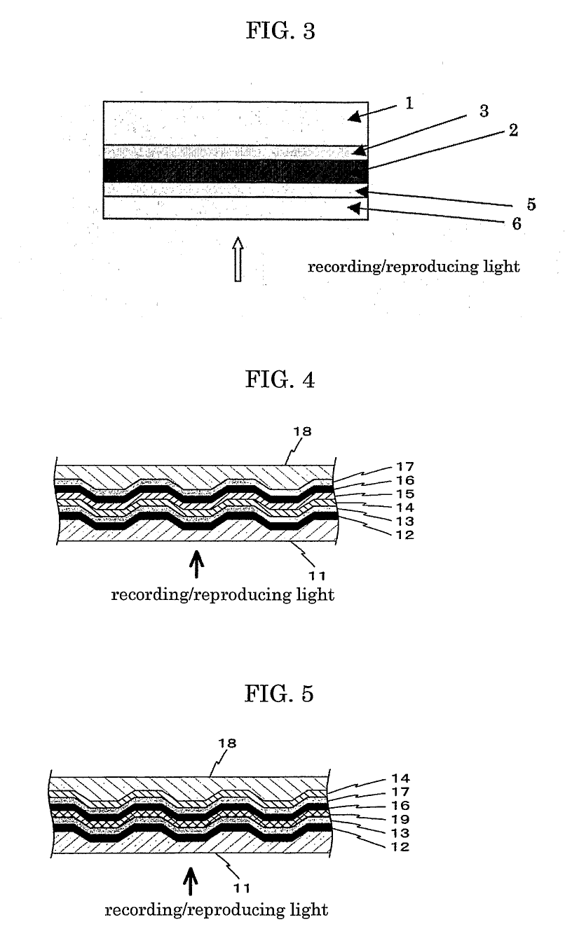

FIG. 2 exemplarily shows a layer configuration of optical recording media of DVD+R or DVD-R; and FIG. 3 exemplarily shows a reverse layer configuration of optical recording media employed in BD-R.

The optical recording medium shown in FIG. 2 has a substrate 1, a dye recording layer (optical recording layer) 2, a reflective layer 3, and a dummy substrate 4 in this order from incident side of laser light.

The optical recording medium shown in FIG. 3 has a light transmissive cover layer 6, a light transmissive protective layer 5, a dye recording layer (optical recording layer) 2, a reflective layer 3, and a substrate 1 in this order from incident side of laser light.

Various layers may also be provided between these layers in order to attain light enhance, protective durability, smoothness, or adhesive property.

### Substrate 1 and Dummy Substrate 4

The material of the substrate 1 and the dummy substrate 4 may be properly selected depending on the purpose; examples thereof include acrylic resins such as polymethylmethacrylate, vinyl chloride resins such as polyvinyl chloride and vinyl chloride copolymers, epoxy resins, polycarbonate resins, amorphous polyolefin, glasses such as soda-lime glass, and ceramics. Among these, polymethylmethacrylate, polycarbonate resins, epoxy resins, amorphous polyolefin, and glasses are preferable in view of dimension stability, transparency, and smoothness; polycarbonate resins are particularly preferable in view of easy formability.

At least one of guide grooves and pits is formed at the substrate 1. The groove depth or groove width (half width) of guide grooves at surface of the substrate 1 may be properly selected depending on recording/reproducing wavelength.

The groove depth is preferably 20 nm to 100 nm, which may provide such benefits that push-pull signal after recording is easily reduced below unrecorded push-pull signal and that unrecorded push-pull signal necessary for track servo is easily obtained.

When DVD laser wavelength of 640 to 680 nm is employed, the groove depth is preferably 30 to 70 nm and the groove width (half width) is preferably 20% to 60% of track pitch. These ranges allow to design recording suited to the DVD laser wavelength and to adjust suitably depending on the signal properties.

Address information and/or medium information may also be recorded previously on guide grooves. These information may be recorded by phase modulating wobbles in DVD+R and by Lpp wobbles in DVD-R. The manners are described in DVD+R System Specifications in cases of DVD+R and in DVD Specifications for Recordable Disc (DVD-R) in cases of DVD-R.

In the present invention, distinguishing information in optical recording media of low-to-high media may be easily added by these coatings, which allows to recognize the medium and to adjust the servo depending on the medium, leading to easy recording and reproducing.

### Pre-Groove Layer

A pre-groove layer may be provided on the substrate 1 (or undercoat layer described later) in order to form concavity and convexity that indicates information such as of guide grooves and address signals.

The material of the pre-groove layer may be properly selected depending on the purpose; examples thereof are mixtures of at least a monomer (or oligomer) of monoesters, diesters, triesters, tetraesters of acrylic acids and a photopolymerization initiator.

### Undercoat Layer

An undercoat layer may be provided on the surface of substrate 1 of the side where the dye recording layer 2 is to be provided and/or on the reflective layer 3, in order to improve smoothness, to raise adhesive force, and to prevent alternation of the dye recording layer 2, and also with an aim of signal enhance.

The material of the undercoat layer may be properly selected depending on the purpose; examples thereof include organic materials of polymer materials, UV curable resins, adhesives, silane coupling agents, etc. such as of polymethylmethacrylate, acrylic acid-methacrylic acid copolymers, styrene-maleic anhydride copolymers, polyvinyl alcohol, N-methylol acrylamide, styrene-vinylsulfonic acid copolymers, styrene-vinyltoluene copolymers, chlorosulfonated polyethylene, nitrocellulose, polyvinyl chloride, chlorinated polyolefins, polyesters, polyimides, vinyl acetate-vinyl chloride copolymers, ethylene-vinyl chloride copolymers, polyethylene, polypropylene, and polycarbonates; and inorganic materials such as inorganic oxides like SiO₂, Al₂O₃, SnO₂, Ta₂O₅, Nb₂O₅, inorganic sulfides like ZnS and SnS, inorganic fluorides like MgF₂, and mixtures thereof.

The thickness of the undercoat layer may be properly selected depending on the application; the thickness is typically about 10 to 20 μm.

### Reflective Layer 3

A reflective layer 3 is provided on the dye recording layer 2 (optical recording layer) in order to improve S/N ratio, reflectance, sensitivity at recording, etc.

The material of the reflective layer 3 is selected from light reflective materials having a higher reflectance to laser lights; examples thereof include metals and metalloids such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ca, In, Si, Ge, Te, Pb, Po, Sn, Si, and Nd. Among these, Au, Al, and Ag are preferable. These light reflective materials may be used alone or in combination of two or more.

When Al or Ag is used as the light reflective material, Ti, Nb, Ta, Mn, Pd, Pt, Zn, Cd, Ca, In, Si, Ge, Sn, Si, Nd, etc. may be added in an amount of 0.1% to 10% by mass.

The thickness of the reflective layer is typically about 10 to 300 nm.

### Protective Layer

A protective layer (overcoat) may be provided on the dye recording layer 2 and/or reflective layer 3 in order to physically chemically protect the layers, and a protective layer (back coat) may also be provided on the substrate 1 of the side without the dye recording layer 2 in order to improve flaw resistance or humidity resistance.

Examples of the protective layer include inorganic materials based on SiO, SiO₂, MgF₂, SnO₂, ZnS, or ZnO, thermoplastic resins, thermo-setting resins, and UV curable resins.

The thickness of the protective layer is typically about 10 nm to 50 μm.

When the protective layer is a resin protective layer, the protective layer may be provided as a light transmissive cover layer 6 as shown in FIG. 3.

An exemplary layer construction of the inventive optical recording media will be explained with reference to FIGS. 4, 5, which comprise a first information layer with a first recording layer and a second information layer with a second recording layer in the following.

FIG. 4 shows an example produced by way of an inverted stack method and FIG. 5 shows an example produced by way of a 2P (Photo Polymerization) method. In FIG. 4, a first dye recording layer 12, a semi-transmissive reflective layer 13, an adhesive layer 14, an inorganic protective layer 15, a second dye recording layer 16, and a reflective layer 17 are laminated in order between a first substrate 11 and a second substrate 18. In FIG. 5, a first dye recording layer 12, a semi-transmissive reflective layer 13, an intermediate layer 19, a second dye recording layer 16, a reflective layer 17, and an adhesive layer 14 are laminated in order between a first substrate 11 and a second substrate 18. Various layers may also be provided between these layers in order to attain light enhance, protective durability, smoothness, etc.

It is preferred that guide grooves having a groove depth of 20 to 100 nm are formed at upper surface of the first substrate 11 and guide grooves having a groove depth of 10 to 40 nm are formed at lower surface of the second substrate 18 in a groove width (half width) of 20% to 60% of track pitch (distance between adjacent grooves); thereby, the value of push-pull signal decreases after recording information and the push-pull signal can be easily obtained in a magnitude necessary for track servo in cases where the information is unrecorded.

The material of the first and the second substrates 11, 18 is similar to those of the substrate 1 described above; the material of the semi-transmissive reflective layer 13 or the reflective layer 17 is similar to those of the reflective layer 3 described above.

It is necessary that the layer thickness of the semi-transmissive reflective layer 13 is adjusted so as to have a light transmittance of 40% or higher, and the thickness is usually in a range of 5 to 30 nm. On the other hand, the reflective layer 17 is formed to a thickness of 60 to 300 nm so as to totally reflect the laser light.

The inorganic protective layer 15 is provided in order to protect chemically and physically the dye recording layer and formed of materials that contain highly transmissive inorganic materials such as SiO, SiO₂, MgF₂, SnO₂, ZnS, ZnS—SiO₂, and ZnS—SiC. Among these, those based on ZnS such as ZnS—SiO₂ and ZnS—SiC are preferable in view of lower crystallinity and higher refractive indices.

The adhesive layer 14 is formed of an adhesive. The adhesive is exemplified by UV curable adhesives, cationic UV curable adhesives, or UV curable adhesives capable of exhibiting adhesive property upon irradiating UV rays. These adhesives are applied onto at least one of facing surfaces of opposing two disc bodies by way of spin coating, etc.

The intermediate layer 19 is formed from a material, for example, that contains thermoplastic resins, thermosetting resins, electron beam curable resins, UV curable resins (including delayed curable type), etc.

When thermoplastic resins or thermosetting resins are used as the material of the intermediate layer 19, these resins are dissolved in an appropriate solvent to form a coating solution, which is then coated on the first substrate 11, on which the semi-transmissive reflective layer 13 being formed, and dried (heated) thereby to form the intermediate layer 19.

When electron beam curable resins or UV curable resins are used as the material of the intermediate layer 19, these resins are used themselves or dissolved in an appropriate solvent to form a coating solution, which is then coated on the first substrate 11, on which the semi-transmissive reflective layer 13 being formed, and electron beam or UV rays are irradiated to cure thereby to form the intermediate layer 19.

The materials described above may be used alone or in combination, and may be applied several times to the first substrate 11 on which the semi-transmissive reflective layer 13 being formed.

In addition, guide grooves may be formed at the intermediate layer 19 similarly as the first and the second substrates 11, 18; thereby, the push-pull signal can be easily reduced after recording compared to before recording. Furthermore, in cases where the information is unrecorded, the push-pull signal can be easily obtained in a magnitude necessary for track servo. In addition, the recording can be designed so as to be suited to the recording/reproducing wavelength and be desirably adjusted to signal properties within the range described above.

### Production of Optical Recording Medium

The method of producing the optical recording media can be properly selected from conventional ones. The optical recording medium shown in FIG. 2, for example, can be produced by a production method comprising a step of forming a dye recording layer, a step of forming a reflective layer, and a step of forming a dummy substrate. The optical recording media shown in FIGS. 4, 5 can be produced by conventional methods such as inverted stack methods and 2P methods.

The inverted stack methods can lead to higher reflective efficiency of the laser light incident to the second dye recording layer. Specifically, intimate contact between the inorganic layer 15 and the second dye recording layer 16 can reduce the damage of the second dye recording layer 16, and the multiple interaction effect at both sides of the second dye recording layer can enhance the reflective efficiency of the laser light incident to the second dye recording layer 16.

In addition, the 2P methods can bring about a groove configuration of the second dye recording layer similar with that of the first dye recording layer, which making possible to enhance recording properties.

### Step of Forming Dye Recording Layer

In the step of forming a dye recording layer, the dye recording layer 2 of the dye material is formed on the substrate 1, having guide grooves and/or pits on the surface, directly or through another layer by means of coating and forming a film.

The dye material is typically dissolved in a solvent to prepare a coating liquid when the dye material is coated; the solvent may be conventional ones such as alcohols, cellosolves, halogenated hydrocarbons, ketones, and ethers, and among these, fluorine-substituted alcohols are preferable in view of higher solubility for the dye material and excellent properties to control layer thickness.

The process of coating and forming a film is preferably a spin-coating process from the viewpoint that the thickness can be controlled by adjusting concentration and viscosity of the dye recording layer and drying temperature of the solvent.

### Step of Forming Reflective Layer

In the step of forming a reflective layer, the reflective layer 3 is formed on the dye recording layer 2 directly or through another layer by means of a vacuum film deposition process. The reflective layer 3 is formed on the dye recording layer 2 from the light reflective material under a vacuum film-forming process through vapor deposition, sputtering, ion plating, etc.

### Step of Forming Dummy Substrate

In the step of forming a dummy substrate, the dummy substrate 4 is formed on the reflective layer 3. The dummy substrate 4 may be formed on the reflective layer 3 using an adhesive, for example, a material for protective layer of a UV curable resin is coated to form a film between the surface of the reflective 3 and the dummy substrate 4 and then curing and laminating are carried out by irradiating UV rays through the dummy substrate 4.

### Optical Recording Method

The inventive optical recording media can be recorded in low-to-high mode by way of irradiating a pulse light employed in conventional optical recording systems such as of CD-R, DVD+R, DVD-R, HD DVD-R, and BD-R. Consequently, the optical recording medium can undergo recording excellent in recording sensitivity (light absorptance) and superior in recording properties at high-speed recording and also be optionally treated with the other processes.

The pulse light may be properly selected from conventional pulse light depending on the purpose and may contain multi-pulse light, pulse light of which intensity being modified at its head portion, or pulse light of which intensity being modified at its head and tail portions. Recording by use of the pulse light may lead to record appropriate signals and employ the recording pulse strategy such as described in DVD+R system specifications.

### Optical Recording Apparatus

The optical recording apparatus typically comprises a laser source such as semiconductor lasers, a collecting lens that collects laser light emitted from the laser source to optical recording medium mounted to spindles, a laser light detector that detects a part of the later light emitted from the laser source, and an optical element that directs the later light emitted from the laser source to the collecting lens and the laser light detector, and optional other units as required.

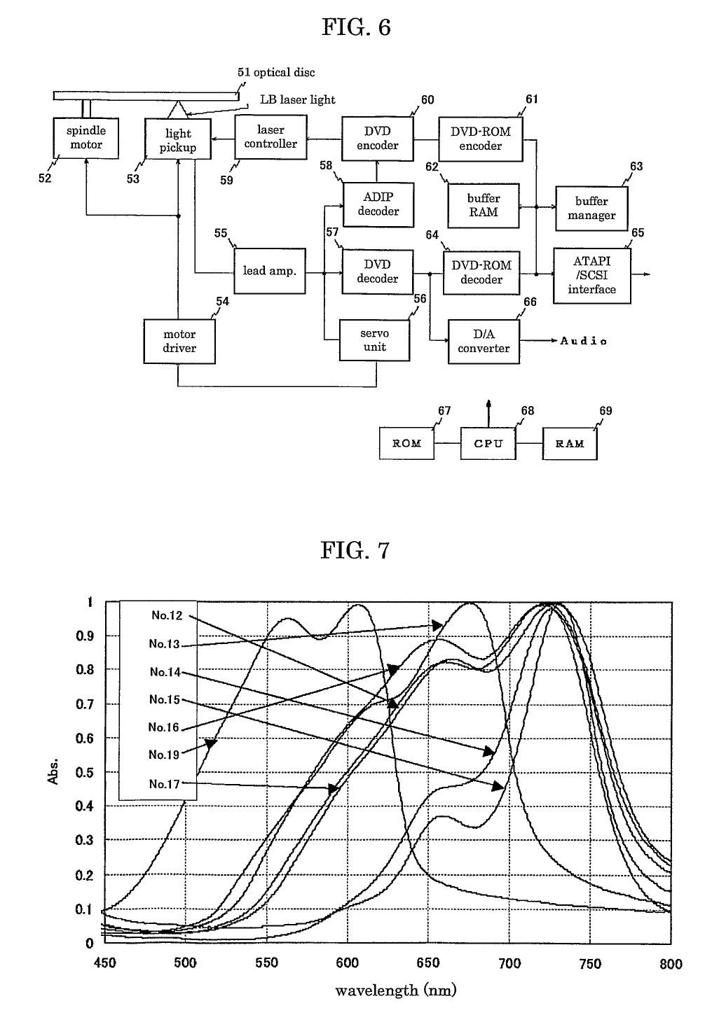

FIG. 6 shows a constitutional example of the optical recording apparatus, in which laser light emitted from the laser source is directed to the collecting lens by the optical element, the laser light is collected and irradiated to record the optical recording medium by the collecting lens. At the same time, the optical recording apparatus directs a part of the later light emitted from the laser source to the laser light detector, and light amount of the laser source is controlled based on the detected amount of the laser light at the laser light detector. The laser light detector converts the detected amount of the laser light and outputs as a signal of the detected amount. The light pickup 53 (recording unit) shown in FIG. 6 is constructed from these laser light source, optical element, collecting lens, laser light detector, etc.

The other units described above are exemplified by control units (distinguishing units). The control units may be properly selected as long as capable of controlling the actions of the units and are exemplified by instruments such as sequencers and computers.

It is also preferred in the present invention that the fact to be a low-to-high recording medium is distinguished previously. When determined based on radial contrast, the determination can be easily carried out by recording and reproducing on trial at the recording management region and detecting the radial contrast.

It is also preferred that the fact to be an optical recording medium of low-to-high type is recorded as information at guide grooves, which leads common distinguishing motions with existing media.

The optical recording apparatus has a unit to acquire contents information (e.g. interface) through network. The acquiring unit may be ones to acquire contents information from portable memory media such as CD, DVD, and USB memories.

In addition, contents information is read out from internet or portable recording media, which is then combined with inventive optical recording media, thereby the contents information can be effectively recorded and contents-recorded media can be provided with excellent reproduction compatibility.

The inventive system to prepare the contents-recorded optical recording media is equipped with the inventive optical recording apparatus of <17> described above and a server connected to the optical recording apparatus through network. The optical recording apparatus acquires contents information through network and records the acquired contents information on the optical recording medium, capable of recording in low-to-high described above, by an optical pickup 53 while being controlled by the laser controller 59 as well as the access region is made recorded.

The content-recorded optical recording media, prepared by this system, represent lower push-pull signals after recording. Therefore, they can solve the above-noted problems in relation to illegal copies thus can contribute to provision of new business forms that take copyright protection into consideration.

The present invention can provide optical recording media that comprise a dye recording layer capable of recording by use of recording light with a wavelength of 640 to 680 nm or 400 to 410 nm, record in low-to-high mode, and exhibit excellent recording sensitivity. The present invention can also provide optical recording apparatuses to record the optical recording media and systems to prepare contents-recorded optical recording media by use of the optical recording apparatuses.

### EXAMPLES

Examples of the present invention will be explained in the following, but to which the present invention should in no way be limited.

### Example 1

A substrate 1 of a polycarbonate disc of 120 mm diameter and 0.6 mm thick was obtained that had a concavo-convex pattern of guide grooves with about 700 Å deep, about 0.24 μm of groove bottom width, and 0.74 μm of track pitch in accordance with DVD+R format.

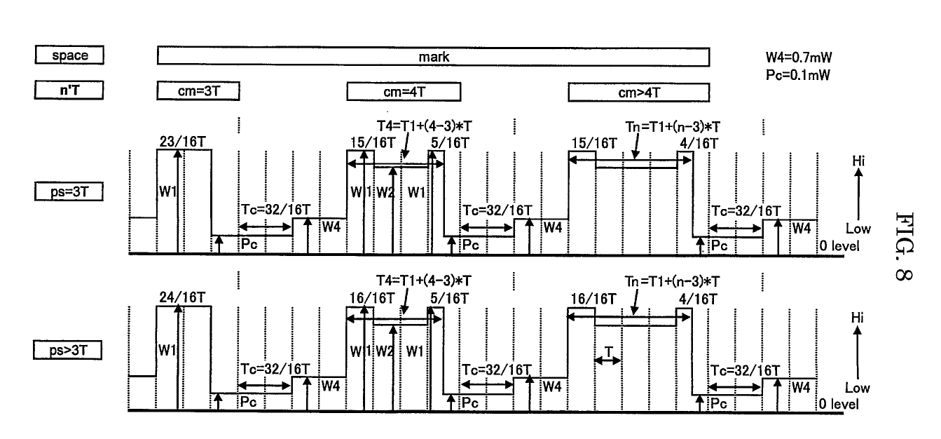

Then the cyanine dye No. 12 shown below was dissolved in 2,2,3,3-tetrafluoropropanol to prepare a coating liquid for dye recording layer, which was then spin-coated on the substrate 1 and annealed at 90° C. for 15 minutes thereby to form a dye recording layer 2. The maximum light absorption wavelength of the dye recording layer 2 was 730 nm, the light absorption (Abs.) was 0.55 at the maximum light absorption wavelength, and the light absorption (Abs.) was 0.49 at the recording/reproducing wavelength 650 nm. Separately, the dye recording layer was formed on a glass plate, and the light absorption spectrum thereof is shown in FIG. 7.

No. 12 (in the chemical formula below, Me represents a methyl group and Bu represents a butyl group)

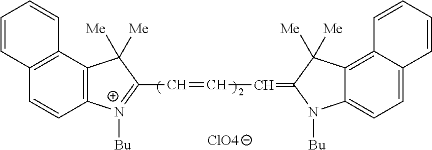

Then a Ag—In alloy (In: 0.5% by mass) was deposited to about 140 nm thick on the dyer recording layer 2 by a sputtering process using Ar as a sputtering gas to form a reflective layer 3.

Further, a protective layer of a UV curable resin (SD390, by Dainippon Ink and Chemicals, Inc.) was formed thereon by about 4 μm thick to form a disc body, which was then laminated with a dummy substrate 4 (cover substrate) of polycarbonate having the same size with the substrate 1 using a UV curable adhesive (DVD802, by Nippon Kayaku Co.) thereby to produce an optical recording medium of DVD+R.

The properties of the optical recording medium were evaluated using an optical disc evaluation device ODU-1000 (by Pulstec Industrial Co.) in accordance with DVD+R system specifications. The processes to measure push-pull signal, differential signal, reflectance, signal modulation degree (I14/I14H), etc. were based on the system specifications, and light absorbance (Abs.), maximum absorption peak wavelength, light absorption spectra of dyes, etc. were measured using a spectral photometer (Hitachi Ratio Beam Spectrophotometer Type U-1000, by Hitachi Ltd.).

### Signal Recording

DVD (8-16) signals were recorded under the conditions of wavelength: 659 nm, NA: 0.65, and linear velocity: 8× (27.92 m/s). In the recording, a castle pattern of pulse light emission was employed in accordance with DVD+R system specifications (see FIG. 8).

### Signal Reproduction

Unrecorded and recorded signals were measured under the condition of wavelength: 659 nm, NA: 0.65, and linear velocity: 1× (3.49 m/s).

From the results shown in Table 2, it was confirmed that the recording is of low-to-high mode in which reflectance increases after recording and that push-pull signal decreases after recording.

“L to H” in the column of recording mode is a shorten expression of “Low-to-high” and “H to L” is that of “High-to-low”; and the values at the column “PPa/PPb” are those of a push-pull signal after recording (PPa) divided by a push-pull signal before recording (PPb) (unrecorded).

### Example 2

An optical recording medium of DVD+R was produced and evaluated in the same manner as Example 1 except that the dye in the dye recording layer 2 was changed into the squarylium dye No. 13 shown below. The results are shown in Table 2. Separately, the dye recording layer was formed on a glass plate, and the light absorption spectrum thereof is shown in FIG. 7.

### No. 13

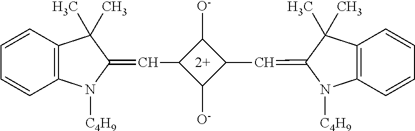

### Example 3

An optical recording medium of DVD+R was produced and evaluated in the same manner as Example 1 except that the dye in the dye recording layer 2 was changed into the phthalocyanine dye No. 14 shown below and 2,2,3,3-tetrafluoropropanol was changed into a mixture of 2,2,3,3-tetrafluoropropanol, ethylcyclohexane, and 1-methoxy-2-butanol. The results are shown in Table 2. Separately, the dye recording layer was formed on a glass plate, and the light absorption spectrum thereof is shown in FIG. 7.

No. 14 (in the chemical formula, R¹ and R³ each represent CF₃, R² represents a phenyl group, and M represents VO (vanadium oxide))

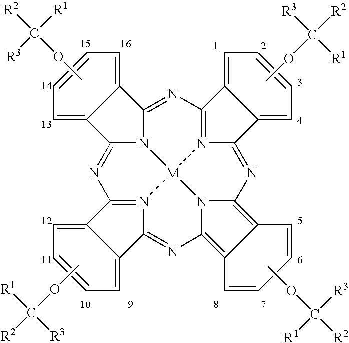

### Example 4

An optical recording medium of DVD+R was produced and evaluated in the same manner as Example 1 except that the dye in the dye recording layer 2 was changed into the phthalocyanine dye No. 15 shown below and 2,2,3,3-tetrafluoropropanol was changed into ethylcyclohexane. The results are shown in Table 2. Separately, the dye recording layer was formed on a glass plate, and the light absorption spectrum thereof is shown in FIG. 7.

No. 15 (in the chemical formula, one of Y¹ and Y², one of Y³ and Y⁴, one of Y⁵ and Y⁶, and one of Y⁷ and Y⁸ represent —O—CH[CH(CH₃)₂]₂, and the others represent Br; Met represents Pd)

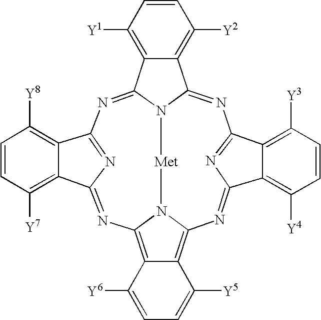

### Example 5

An optical recording medium of DVD+R was produced and evaluated in the same manner as Example 1 except that the dye in the dye recording layer 2 was changed into the cyanine dye No. 16 shown below. The results are shown in Table 2. Separately, the dye recording layer was formed on a glass plate and the light absorption spectrum thereof is shown in FIG. 7. Optical recording media (Examples 5-1 to 5-4) were also produced with changing the thickness of the dye recording layer and the results of recording/reproducing signals are shown in Table 3. The meaning of “L to H” and “H to L” at the columns of recording mode and the meaning of the values at the column “PPa/PPb” are the same as those of Table 2.

No. 16 (in the chemical formula, Me represents a methyl group and Et represents an ethyl group)

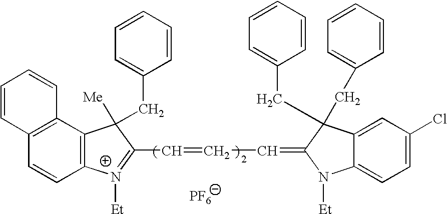

### Example 6

An optical recording medium of DVD+R was produced and evaluated in the same manner as Example 5 except that the dye in the dye recording layer 2 was changed into the cyanine dye No. 17 shown below. The results are shown in Table 3. Separately, the dye recording layer was formed on a glass plate and the light absorption spectrum thereof is shown in FIG. 7.

No. 17 (in the chemical formula, Me represents a methyl group)

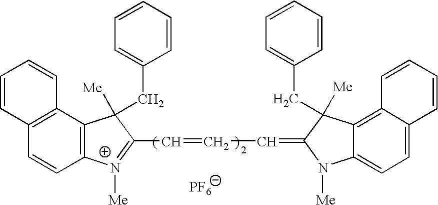

### Example 7

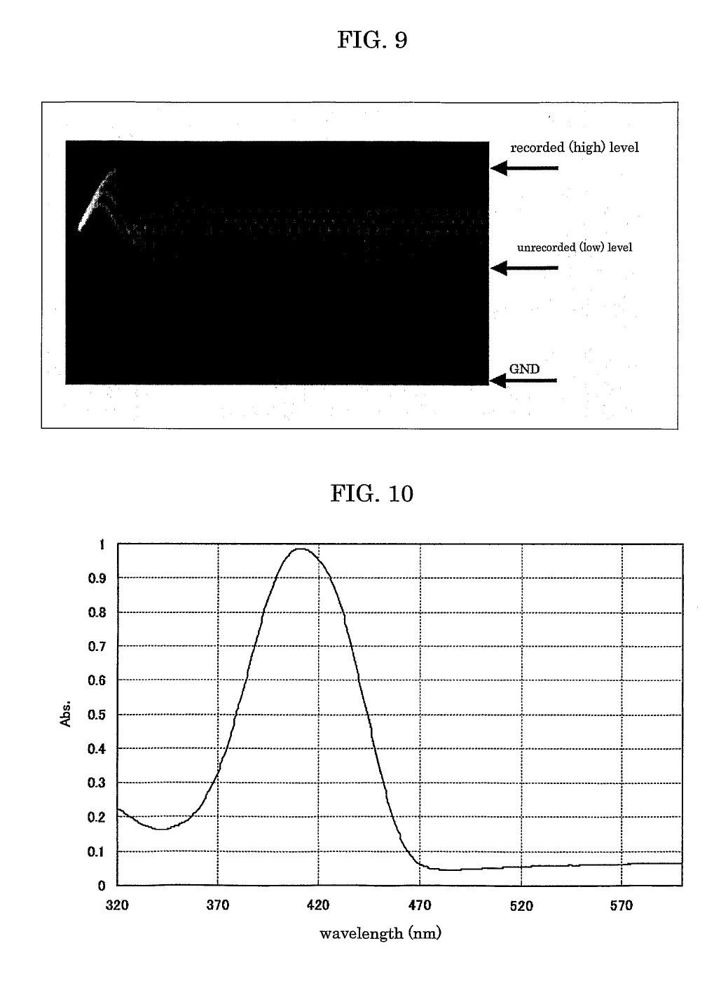

An optical recording medium of DVD+R was produced and evaluated in the same manner as Example 5 except that the dye in the dye recording layer 2 was changed into a mixture of the cyanine dye No. 16 added with the formazan chelate dye No. 18 shown below in an amount of 30% by mass. The results are shown in Table 3. The wave profile (eye pattern) of reproduction signal of this optical recording medium is shown in FIG. 9.

No. 18 (in the chemical formula, Ph represents a phenyl group)

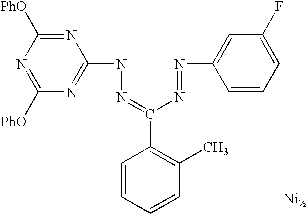

### Example 8

An optical recording medium of DVD+R was produced and evaluated in the same manner as Example 5 except that the depth of the guide grooves was changed from 700 Å into 1000 Å. The results are shown in Table 3.

### Example 9

An optical recording medium of DVD+R was produced and evaluated in the same manner as Example 5 except that the depth of the guide grooves was changed from 700 Å into 305 Å and the dye in the dye recording layer 2 was changed into a mixture of the cyanine dye No. 17 added with the formazan chelate dye No. 18 shown below in an amount of 20% by mass. The results are shown in Table 3.

### Comparative Examples 1 and 2

Optical recording media of DVD+R of Comparative Examples 1 and 2 were produced and evaluated in the same manner as Example 1 except that the dye in the dye recording layer 2 was changed into the squarylium dye No. 19 shown below and that the depth of the guide grooves of the substrate 1 was changed into 1500 Å in Comparative Example 1. Separately, the dye recording layer was formed on a glass plate and the light absorption spectrum thereof is shown in FIG. 7.

From the results shown in Table 3, it was confirmed that the recording is of high-to-low mode in which reflectance decreases after recording and that push-pull signal increased after recording.

### No. 19

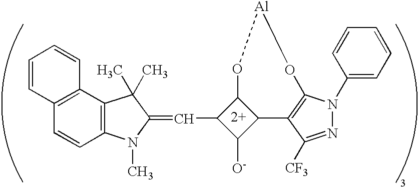

TABLE 2

| Ex- | | | | | | re- | |
|---|---|---|---|---|---|---|---|
| am- | | groove | | Abs | Abs | cording | PPa/ |
| ple | dye | depth | (λmax) | (λmax) | (650 nm) | mode | PPb* |
| 1 | No. 12 | 700 Å | 730 nm | 0.55 | 0.49 | L to H | 0.75 |
| 2 | No. 13 | 700 Å | 680 nm | 0.45 | 0.43 | L to H | 0.75 |
| 3 | No. 14 | 700 Å | 730 nm | 0.58 | 0.28 | L to H | 0.95 |
| 4 | No. 15 | 700 Å | 730 nm | 0.50 | 0.23 | L to H | 0.98 |
| 5-3 | No. 16 | 700 Å | 722 nm | 0.68 | 0.58 | L to H | 0.83 |

*push-pull after recording/push-pull before recording

TABLE 3

| | | | | | | recording | | |
|---|---|---|---|---|---|---|---|---|
| | | | | | | power | | |
| | | groove | | | | (mW) | | recording |
| Example | dye | depth | λmax | Abs (λmax) | Abs (650 nm) | W1 | W2 | mode |
| 5-1 | No. 16 | 700 Å | 722 nm | 0.88 | 0.78 | 30 | 20 | L to H |
| 5-2 | No. 16 | 700 Å | 722 nm | 0.77 | 0.67 | 30 | 20 | L to H |
| 5-3 | No. 16 | 700 Å | 722 nm | 0.68 | 0.58 | 30 | 20 | L to H |
| 5-4 | No. 16 | 700 Å | 722 nm | 0.60 | 0.50 | 30 | 20 | L to H |
| 6 | No. 17 | 700 Å | 728 nm | 0.82 | 0.56 | 30 | 20 | L to H |
| 7 | No. 16, 18 | 700 Å | 722 nm | 0.58 | 0.49 | 30 | 20 | L to H |
| 8 | No. 16 | 1000 Å | 722 nm | 0.65 | 0.55 | 30 | 20 | L to H |
| 9 | No. 17, 18 | 305 Å | 728 nm | 0.66 | 0.45 | 30 | 20 | L to H |
| Com. Ex. 1 | No. 19 | 1500 Å | 606 nm | 0.61 | 0.12 | 37 | 25 | H to L |
| Com. Ex. 2 | No. 19 | 700 Å | 606 nm | 0.65 | 0.13 | 32 | 22 | H to L |

| | | | | | modulation | | |
|---|---|---|---|---|---|---|---|
| | reflectance (%) | | push-pull | | degree (%) | | |
| Example | unrecorded | recorded | unrecorded | recorded | I14/I14H | jitter (%) | PPa/PPb * |
| 5-1 | 9 | 29 | 0.61 | 0.39 | 71 | 8.5 | 0.63 |
| 5-2 | 13 | 36 | 0.55 | 0.40 | 61 | 8.8 | 0.73 |
| 5-3 | 19 | 39 | 0.50 | 0.42 | 50 | 9.0 | 0.83 |
| 5-4 | 22 | 36 | 0.48 | 0.42 | 40 | 11.0 | 0.88 |
| 6 | 18 | 46 | 0.55 | 0.35 | 65 | 7.8 | 0.64 |
| 7 | 19 | 36 | 0.49 | 0.41 | 49 | 9.0 | 0.84 |
| 8 | 14 | 33 | 0.65 | 0.65 | 58 | 9.5 | 1.00 |
| 9 | 22 | 38 | 0.26 | 0.19 | 41 | 8.2 | 0.73 |
| Com. Ex. 1 | 46 | 12 | 0.54 | 0.73 | 75 | 8.2 | 1.35 |
| Com. Ex. 2 | 53 | 31 | 0.16 | 0.35 | 38 | 12.0 | 2.19 |

### Example 10

A substrate 1 of a polycarbonate disc of 120 mm diameter and 0.6 mm thick was obtained that had a concavo-convex pattern of guide grooves with about 600 Å deep, about 0.20 μm of groove bottom width, and 0.40 μm of track pitch in accordance with HD DVD-R format.

Then the cyanine dye No. 20 shown below was dissolved in 2,2,3,3-tetrafluoropropanol to prepare a coating liquid for dye recording layer, which was then spin-coated on the substrate 1 and annealed at 90° C. for 15 minutes thereby to form a dye recording layer 2. The maximum light absorption wavelength of the dye recording layer 2 was 412 nm, and the light absorption (Abs.) was 0.3 at the maximum light absorption wavelength.

Then a Ag—In alloy (In: 0.5% by mass) was deposited to about 140 nm thick on the dyer recording layer 2 by a sputtering process using Ar as a sputtering gas to form a reflective layer 3.

Further, a protective layer of a UV curable resin was formed thereon by about 4 μm thick to form a disc body, which was then laminated with a dummy substrate 4 (cover substrate) of polycarbonate having the same size using a UV curable adhesive (DVD802, by Nippon Kayaku Co.) thereby to produce an optical recording medium of HD DVD-R. Separately, the dye recording layer was formed on a glass plate and the light absorption spectrum thereof is shown in FIG. 10.

No. 20 (in the chemical formula, Me represents a methyl group)

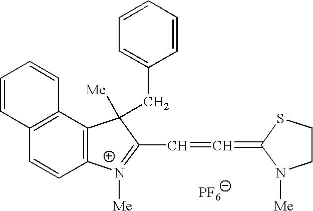

The optical recording medium of Example 10 was evaluated using an optical disc evaluation device ODU-1000 (by Pulstec Industrial Co.). Evaluation conditions were as follows.

### Signal Recording

HD DVD signals were recorded under the conditions of wavelength: 406 nm, NA: 0.65, and linear velocity: 2× (13.22 m/s). In the recording, a multipulse light emission pattern was employed in accordance with HD DVD+R system specifications (see FIG. 8).

### Signal Reproduction

Unrecorded and recorded signals were measured under the condition of wavelength: 406 nm, NA: 0.65, and linear velocity: 1× (6.61 m/s).

Consequently, it was confirmed that the mode was low-to-high in which reflectance increases after recording and push-pull signal decreases after recording such that the push-pull signal was 0.33 before recording and 0.19 after recording.

### Example 11

A substrate 1 of a polycarbonate disc of 120 mm diameter and 0.6 mm thick was obtained that had a concavo-convex pattern of guide grooves with about 700 Å deep, about 0.24 μm of groove bottom width, and 0.74 μm of track pitch in accordance with DVD+R format.

Then No. 21 cyanine dye shown below as a dye material (A), No. 22 cyanine dye shown below as a dye material (B), and No. 23 dithiol Ni complex shown below as a light resistant material (C) were dissolved into 2,2,3,3-tetrafluoropropanol in a mass ratio of A/B/C=6/2/2 thereby to prepare a coating liquid for the dye recording layer 2, which was then spin-coated on the substrate 1 and annealed at 90° C. for 15 minutes thereby to form a dye recording layer 2.

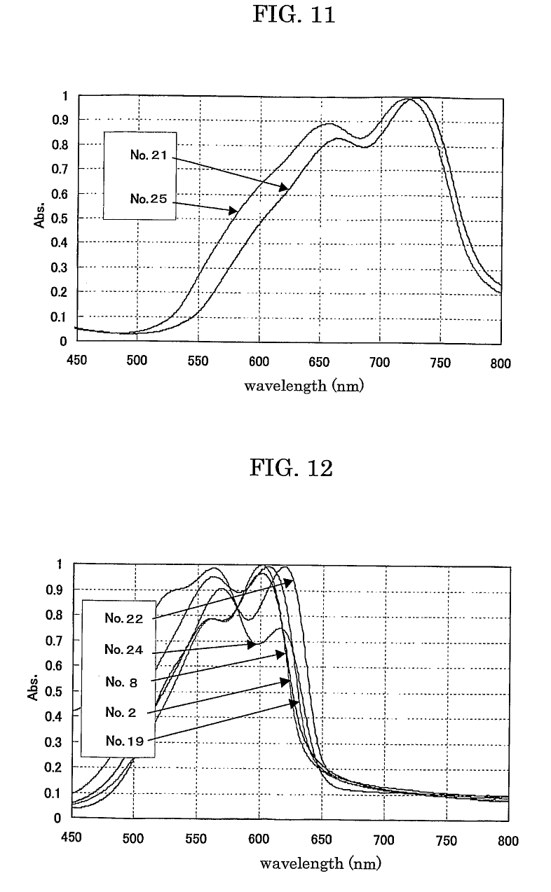

The maximum light absorption wavelength of the dye recording material (A) was 728 nm, and the light absorption (Abs.) was 0.58 at this wavelength; the maximum light absorption wavelength of the dye recording material (B) was 619 nm, and the light absorption (Abs.) was 0.36 at this wavelength. The light absorption (Abs.) of the dye recording layer 2 was 0.44 at the recording/reproducing wavelength of 650 nm. These results are shown in Table 4. Separately, the dye recording layers were formed on a glass plate and the light absorption spectra thereof are shown in FIGS. 11 to 13.

Then a Ag—In alloy (In: 0.5% by mass) was deposited to about 140 nm thick on the dyer recording layer 2 by a sputtering process using Ar as a sputtering gas to form a reflective layer 3.

Further, a protective layer of a UV curable resin (SD390, by Dainippon Ink and Chemicals, Inc.) was formed thereon by about 4 μm thick to form a disc body, which was then laminated with a dummy substrate 4 (cover substrate) of polycarbonate having the same size with the substrate 1 using a UV curable adhesive (DVD802, by Nippon Kayaku Co.) thereby to produce an optical recording medium of DVD+R.

No. 21 (in the chemical formula, Me represents a methyl group)

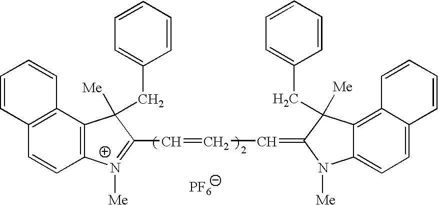

No. 22 (in the chemical formula, Me represents a methyl group)

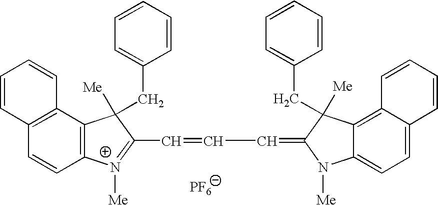

### No. 23

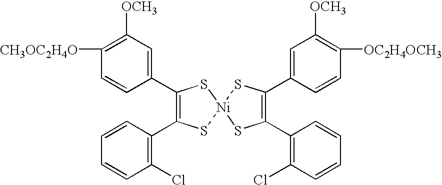

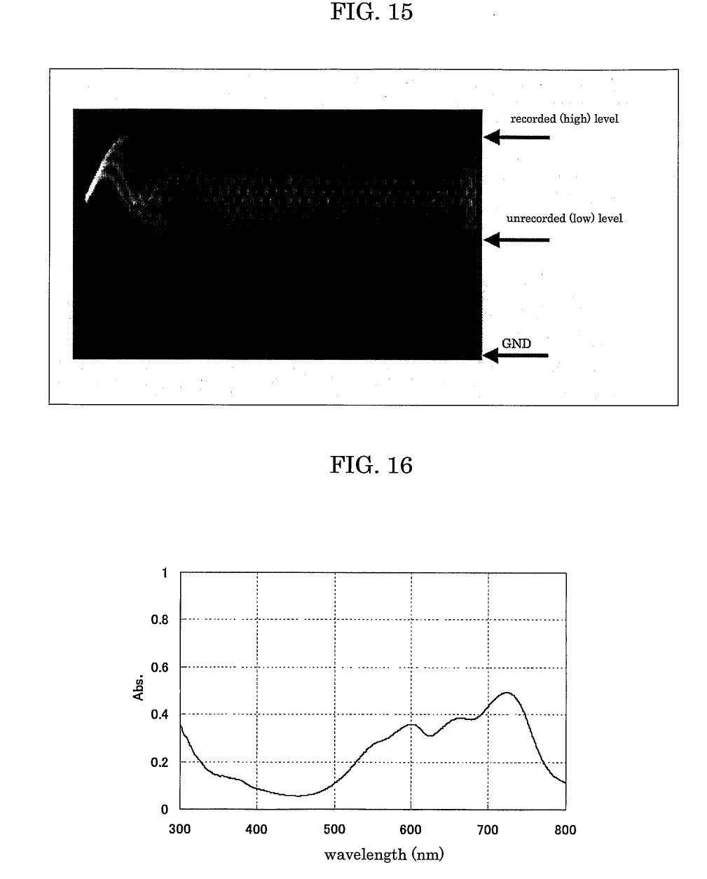

The optical recording medium described above was evaluated for its properties as in Example 1 and also push-pull signal, differential signal, reflectance, signal modulation degree (I14/I14H), light absorbance (Abs.), maximum absorption peak wavelength, light absorption spectra of dyes, etc. were measured. The processes of signal recording and signal reproduction are similar to those of Example 1. The wave profile (eye pattern) of reproduction signal of this optical recording medium is shown in FIG. 15.

The results shown in Table 5 demonstrate that the optical recording medium of this Example is of low-to-high type in which reflectance increases at recording portions after recording and that the push-pull signal decreases after recording. The meaning of “L to H” and “H to L” at the columns of recording mode and the meaning of the values at the column “PPa/PPb” are the same as those of Table 2.

In addition, although the results of recording and reproducing are illustrated at a wavelength of 659 nm in this Example, similar properties are obtainable even when the laser wavelength is fluctuated about ±20 nm due to difference of solid materials or temperatures; the reason is that light absorption of the dye material (A) gently alternates in a range of 640 to 680 nm in the present invention although light absorption rapidly alternates at the DVD laser light wavelength of about 650 nm as shown in FIG. 1 in conventional high-to-low DVD+R.

### Example 12

An optical recording medium of DVD+R was produced and evaluated in the same manner as Example 11 except that the groove depth of the substrate 1 was changed into about 305 Å and the groove bottom width was changed into about 0.25 μm. The results are shown in Tables 4 and 5.

### Example 13

An optical recording medium was produced and evaluated in the same manner as Example 11 except that the dye material (B) of the dye recording layer 2 was changed into the complex salt No. 24 of a cyanine dye and an azo dye to adjust the mass ratio A/B/C of 7/1.5/1.5. The results are shown in Tables 4 and 5. Separately, the dye recording layers were formed on a glass plate and the light absorption spectra thereof are shown in FIGS. 11 to 13.

### No. 24

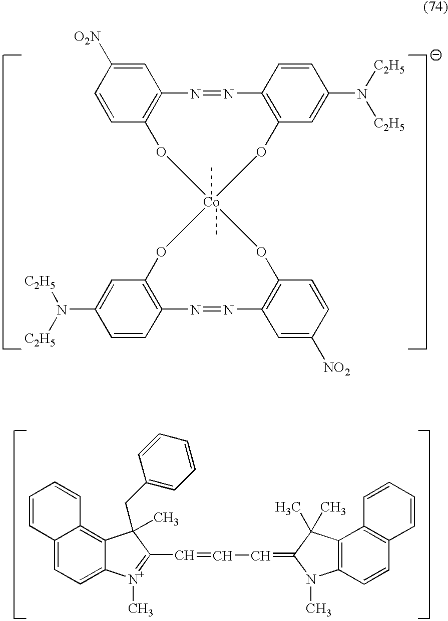

### Example 14

An optical recording medium of DVD+R was produced and evaluated in the same manner as Example 13 except that the groove depth of the substrate 1 was changed into about 305 Å and the groove bottom width was changed into about 0.25 μm. The results are shown in Tables 4 and 5.

### Example 15

An optical recording medium of DVD+R was produced and evaluated in the same manner as Example 11 except that the dye material (B) of the dye recording layer 2 was changed into the squarylium chelate complex No. 8. The results are shown in Tables 4 and 5. Separately, the dye recording layers were formed on a glass plate and the light absorption spectra thereof are shown in FIGS. 11 to 13.

### Example 16

An optical recording medium was produced and evaluated in the same manner as Example 15 except that the groove depth of the substrate 1 was changed into about 305 Å and the groove bottom width was changed into about 0.25 μm. The results are shown in Tables 4 and 5.

### Example 17

An optical recording medium of DVD+R was produced and evaluated in the same manner as Example 12 except that No. 25 cyanine dye shown below as a dye material (A), No. 2 squarylium chelate dye described above as a dye material (B), No. 23 dithiol Ni complex described above as a light resistant material (C), and No. 26 formazan chelate dye shown below as a light resistant material (D) were dissolved into 2,2,3,3-tetrafluoropropanol in a mass ratio of A/B/C/D=5/2.5/1.7/0.8 thereby to prepare a coating liquid for the dye recording layer 2. The results are shown in Tables 4 and 5. Separately, the dye recording layers were formed on a glass plate and the light absorption spectra thereof are shown in FIGS. 11 to 13.

No. 25 (in the formula, Me represents a methyl group and Et represents an ethyl group)

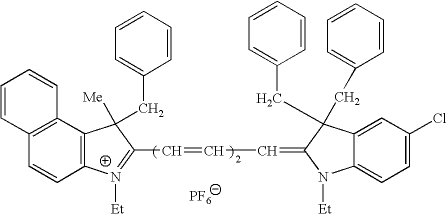

No. 26 (in the formula, Ph represents a phenyl group)

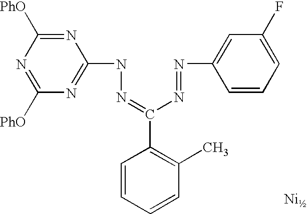

### Example 18

An optical recording medium of DVD+R was produced and evaluated in the same manner as Example 17 except that the dye material (A) of the dye recording layer 2 was changed into the No. 21 cyanine dye and the dye material (B) was changed into the No. 8 squarylium chelate dye. The results are shown in Tables 4 and 5.

### Example 19

An optical recording medium of DVD+R was produced and evaluated in the same manner as Example 18 except that the content ratio of the materials in the dye recording layer 2 was changed into A/B/C/D=4.5/3.0/1.5/1.0 by mass. The results are shown in Tables 4 and 5. Separately, the dye recording layer was formed on a substrate and the light absorption spectrum thereof is shown in FIG. 16.

### Example 20

An optical recording medium of DVD+R was produced and evaluated in the same manner as Example 18 except that the materials of the dye recording layer 2 were dissolved into 2,2,3,3-tetrafluoropropanol in a content ratio of A/B/C/D=3/4.5/1.0/1.5 by mass thereby to prepare a coating liquid of the dye recording layer. The results are shown in Tables 4 and 5.

### Example 21

An optical recording medium of DVD+R was produced and evaluated in the same manner as Example 11 except that the groove depth of the substrate 1 was changed into about 100 nm and the groove bottom width was changed into about 0.25 μm. The results are shown in Tables 4 and 5.

### Example 22

An optical recording medium of DVD+R was produced and evaluated in the same manner as Example 19 except that the diimmonium compound No. 29 (KAYASORB IRG022, by Nippon Kayaku Co.) was used as the light resistant material (C). The results are shown in Tables 4 and 5.

### Example 23

An optical recording medium of DVD+R was produced and evaluated in the same manner as Example 19 except that the aluminum compound No. 30 (KAYASORB IRG140, by Nippon Kayaku Co.) was used as the light resistant material (C). The results are shown in Tables 4 and 5.

### Example 24

An optical recording medium of DVD+R was produced and evaluated in the same manner as Example 16 except that only the dyes (A) and (B) were used as the dye material to change the content ratio. The results are shown in Tables 4 and 5.

### Comparative Example 3

A substrate 1 of a polycarbonate disc of 120 mm diameter and 0.6 mm thick was obtained that had a concavo-convex pattern of guide grooves with about 1500 Å deep, about 0.24 μm of groove bottom width, and 0.74 μm of track pitch in accordance with DVD+R format.

In addition, No. 1 dye material described above and No. 26 formazan chelate dye as the light resistant material were dissolved into 2,2,3,3-tetrafluoropropanol in a mass ratio of No. 1/No. 26=7.5/2.5 thereby to prepare a coating liquid for the dye recording layer 2.

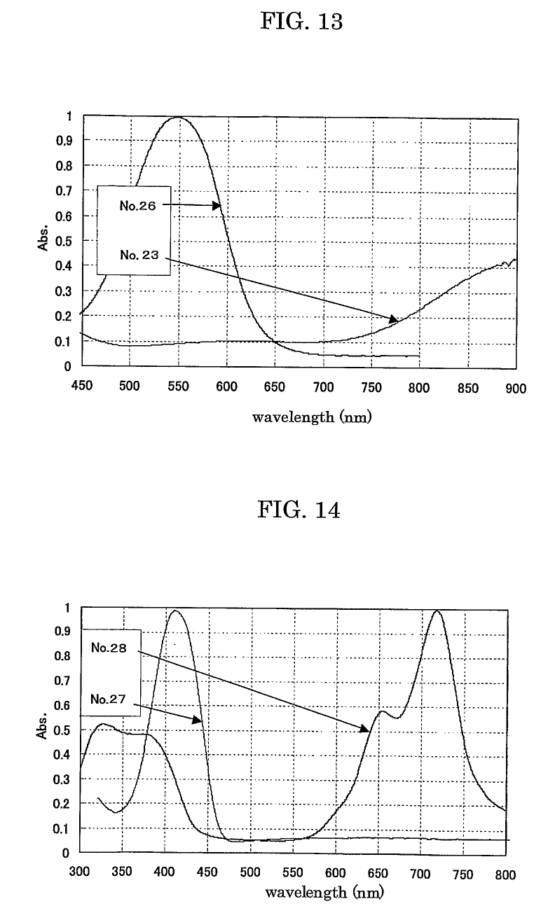

With the same conditions as Example 11 as for the other conditions, an optical recording medium of DVD+R was produced and evaluated. The results are shown in Tables 4 and 5. Separately, the dye recording layers were formed on a glass plate and the light absorption spectra thereof are shown in FIGS. 12 and 13.

The optical recording medium of this Comparative Example was of high-to-low recording mode and the push-pull signal was increased after recording (PPa/PPb=1.35).

Furthermore, the recording sensitivity was poor (W1=37 mW, W2=25 mW), and necessary laser power thereof was 20% or more higher than that of Examples.

### Example 25

The optical recording media of Example 19 and Comparative Example 3 were measured in terms of signals in unrecorded and recorded states under a condition of wavelength: 650 nm, NA: 0.60, and linear velocity: 1× (3.49 m/s). In addition, wavelength-dependent parameters of light absorption wavelength spectrum “n” were calculated.

The results are as follows, which demonstrating that Example 19 is more excellent in wavelength dependency.

reflectance (650 nm): 48% and n=−2 in Example 19

reflectance (650 nm): 42% and n=+30 in Comparative Example 3

### Example 25-2

An optical recording medium of DVD+R was produced and evaluated in the same manner as Example 19 except that the No. 21 cyanine dye was used as the dye material (A) and the No. 26 formazan chelate dye was used as the light resistant material (D) to dissolve into 2,2,3,3-tetrafluoropropanol in a mass ratio of A/D=7.5/2.5 thereby to prepare a coating liquid for the dye recording layer 2. The results are shown in Tables 4 and 5.

The results of this Example 25-2 demonstrate that reflectance and jitter property after recording are inferior compared to those of Examples 17 to 20 that were produced under the same conditions as for grooves and also that modulation properties after recording are inferior compared to those of Examples 12, 14, and 16 to 20.

As shown in Table 5, Examples 11 to 24 exhibit a low-to-high recording mode, push-pull signal decreases after recording, and recorded DVD signals exhibit superior properties.

In addition, Examples 12, 14, 16, 17, 18, 19, 20, 22, 23, and 24, each having a groove depth of 305 Å, are particularly preferable in that the push-pull signal is no more than 0.2 after recording. Furthermore, Examples 17, 18, 19, 20, 22, 23, and 24 exhibit similar properties with commercially available DVD-R with respect to their reflectances after recording (about 45%).

### Example 26

Change of light absorption (Abs.) at λmax after exposing xenon light was measured to compare the light resistance as for the three species of No. 21 dye material-alone dye layer (S-11), the dye layer of Example 25-2 (S-12), and the dye layer of Example 19 (S-13). The exposure condition was 50000 lux.

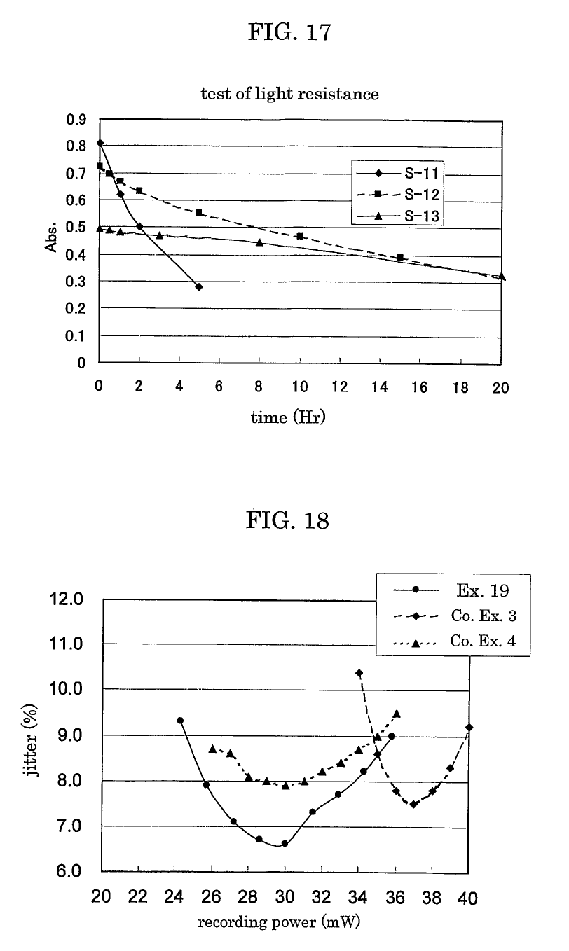

The results, shown in FIG. 17, demonstrate that Example 19 is superior in the light resistance compared to Example 25-2.

The results of evaluating the light resistance for Examples are shown in Table 5. The values of residual rate at the column of the light resistance show residual rates (Abs.) after exposing 20 hours.

### Example 27

Jitter margin to recording power was evaluated with respect to Example 19, Comparative Example 3, and Example 25-2. The evaluation conditions were the same with those of Example 11. The results are shown in FIG. 18.

FIG. 18 demonstrates that the inventive recording medium has an excellent power margin compared to the conventional high-to-low recording medium or the low-to-high recording medium that contains merely No. 21 cyanine dye as the dye material.

### Example 28

A substrate 1 of a polycarbonate disc of 120 mm diameter and 0.6 mm thick was obtained that had a concavo-convex pattern of guide grooves with about 600 Å deep, about 0.24 μm of groove bottom width, and 0.40 μm of track pitch in accordance with HD DVD-R format.

Then No. 27 cyanine dye shown below as a dye material (A) and the No. 28 phthalocyanine dye shown below as a dye material (B) were dissolved into 2,2,3,3-tetrafluoropropanol in a mass ratio of A/B=6/4 thereby to prepare a coating liquid for the dye recording layer 2, which was then spin-coated on the substrate 1 and annealed at 90° C. for 15 minutes thereby to form a dye recording layer 2.

The maximum light absorption wavelength of the dye recording material (A) was 412 nm, and the light absorption (Abs.) was 0.32 at this wavelength; the maximum light absorption wavelength of the dye recording material (B) was 374 nm, and the light absorption (Abs.) was 0.25 at this wavelength. The light absorption (Abs.) of the dye recording layer 2 was 0.29 at the recording/reproducing wavelength of 405 nm. Separately, the dye recording layers were formed on a glass plate and the light absorption spectra thereof are shown in FIG. 14.

Then a Ag—In alloy (In: 0.5% by mass) was deposited to about 100 nm thick on the dyer recording layer 2 by a sputtering process using Ar as a sputtering gas to form a reflective layer 3.

Further, a protective layer of a UV curable resin (SD390, by Dainippon Ink and Chemicals, Inc.) was formed thereon by about 4 μm thick to form a disc body, which was then laminated with a dummy substrate 4 (cover substrate) of polycarbonate having the same size with the substrate 1 using a UV curable adhesive (DVD802, by Nippon Kayaku Co.) thereby to produce an optical recording medium of HD DVD-R.

No. 27 (in the chemical formula, Me represents a methyl group)

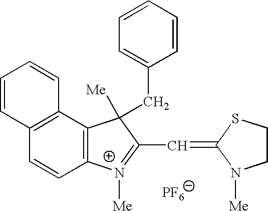

No. 28 (in the chemical formula, one of Y¹ and Y², one of Y³ and Y⁴, one of Y⁵ and Y⁶, and one of Y⁷ and Y⁸ represent the structure shown below and the others represent H)

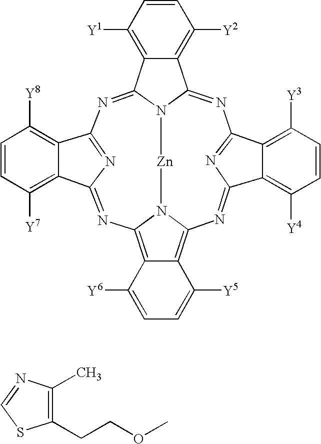

The optical recording medium of Example 28 was evaluated using a disc evaluation device ODU-1000 (by Pulstec Industrial Co.). The evaluating conditions are described in the following.

### Signal Recording

HD DVD signals were recorded under the conditions of wavelength: 406 nm, NA: 0.65, and linear velocity: 2× (13.22 m/s). In the recording, a multi-pulse pattern of light emission was employed in accordance with the HD DVD-R system specifications.

### Signal Reproduction

Unrecorded and recorded signals were measured under a condition of wavelength: 406 nm, NA: 0.65, and linear velocity: 1× (6.61 m/s). Consequently, it was confirmed that the mode was low-to-high in which reflectance increases at recording portions, the unrecorded push-pull signal was 0.35, the recorded push-pull signal was 0.21, and push-pull signal decreases after recording; and PRSNR was 19 dB.

TABLE 4

| | | | | | | | λmax | | | | | | |
|---|---|---|---|---|---|---|---|---|---|---|---|---|---|
| | | | light | light | | | | | light | light | | | |
| | | | resistant | resistant | | | | | resistant | resistant | | | |
| | | | material | material | ratio | | | | material | material | Abs (λmax) | | Abs |
| Example | dye (A) | dye (B) | (C) | (D) | (A/B/C/D) | groove depth | dye (A) | dye (B) | (C) | (D) | dye (A) | dye (B) | (650 nm) |
| 11 | No. 21 | No. 22 | No. 23 | | 6/2/2/0 | 700 Å | 728 nm | 619 nm | >900 nm | | 0.58 | 0.36 | 0.44 |
| 12 | No. 21 | No. 22 | No. 23 | | 6/2/2/0 | 305 Å | 728 nm | 619 nm | >900 nm | | 0.58 | 0.36 | 0.44 |
| 13 | No. 21 | No. 24 | No. 24 | | 7/1.5/1.5/0 | 700 Å | 728 nm | 616 nm | 616 nm | | 0.59 | 0.32 | 0.43 |
| 14 | No. 21 | No. 24 | No. 24 | | 7/1.5/1.5/0 | 305 Å | 728 nm | 616 nm | 616 nm | | 0.59 | 0.32 | 0.43 |
| 15 | No. 21 | No. 8 | No. 23 | | 6/2/2/0 | 700 Å | 728 nm | 601 nm | >900 nm | | 0.56 | 0.30 | 0.43 |
| 16 | No. 21 | No. 8 | No. 23 | | 6/2/2/0 | 305 Å | 728 nm | 601 nm | >900 nm | | 0.56 | 0.30 | 0.43 |
| 17 | No. 25 | No. 2 | No. 23 | No. 26 | 5/2.5/1.7/0.8 | 305 Å | 722 nm | 601 nm | >900 nm | 548 nm | 0.52 | 0.34 | 0.42 |
| 18 | No. 21 | No. 8 | No. 23 | No. 26 | 5/2.5/1.7/0.8 | 305 Å | 728 nm | 601 nm | >900 nm | 548 nm | 0.52 | 0.34 | 0.39 |
| 19 | No. 21 | No. 8 | No. 23 | No. 26 | 4.5/3/1.5/1 | 305 Å | 728 nm | 601 nm | >900 nm | 548 nm | 0.49 | 0.36 | 0.37 |
| 20 | No. 21 | No. 8 | No. 23 | No. 26 | 3/4.5/1/1.5 | 305 Å | 728 nm | 601 nm | >900 nm | 548 nm | 0.40 | 0.42 | 0.32 |
| 21 | No. 21 | No. 22 | No. 23 | | 6/2/2/0 | 1000 Å | 728 nm | 619 nm | >900 nm | | 0.58 | 0.36 | 0.44 |
| 22 | No. 21 | No. 8 | No. 29 | No. 26 | 4.5/3/1.5/1 | 305 Å | 728 nm | 601 nm | >900 nm | 548 nm | 0.49 | 0.36 | 0.37 |
| 23 | No. 21 | No. 8 | No. 30 | No. 26 | 4.5/3/1.5/1 | 305 Å | 728 nm | 601 nm | >900 nm | 548 nm | 0.49 | 0.36 | 0.37 |
| 24 | No. 21 | No. 8 | | | 6/4/0/0 | 305 Å | 728 nm | 601 nm | | | 0.51 | 0.38 | 0.37 |

| | | | | | | | | |
|---|---|---|---|---|---|---|---|---|
| Com. Ex. 3 | No. 1 | No. 26 | 0/7.5/0/2.5 | 1500 Å | 606 nm | 548 nm | 0.60 | 0.13 |

| | | | | | | | | |
|---|---|---|---|---|---|---|---|---|
| 25--2 | No. 21 | No. 26 | 7.5/0/0/2.5 | 305 Å | 728 nm | 548 nm | 0.66 | 0.45 |

TABLE 5

| | recording | | | | | | | | | | residual |
|---|---|---|---|---|---|---|---|---|---|---|---|
| | power | | | | | | | modulation | | | rate |
| | (mW) | | recording | reflectance (%) | | push-pull | | degree (%) | jitter | | in light |
| Example | W1 | W2 | mode | unrecorded | recorded | unrecorded | recorded | I14/I14H | (%) | PPa/PPb | resistance |
| 11 | 30 | 20 | L to H | 11 | 24 | 0.66 | 0.62 | 53 | 10.5 | 0.94 | 0.63 |
| 12 | 30 | 20 | L to H | 19 | 33 | 0.24 | 0.20 | 44 | 9.4 | 0.81 | 0.63 |
| 13 | 30 | 20 | L to H | 12 | 27 | 0.68 | 0.62 | 54 | 8.8 | 0.91 | 0.43 |
| 14 | 30 | 20 | L to H | 21 | 38 | 0.25 | 0.18 | 45 | 7.9 | 0.72 | 0.43 |
| 15 | 30 | 20 | L to H | 12 | 29 | 0.64 | 0.57 | 57 | 10.5 | 0.89 | 0.48 |
| 16 | 30 | 20 | L to H | 20 | 38 | 0.25 | 0.17 | 46 | 7.7 | 0.68 | 0.48 |
| 17 | 30 | 20 | L to H | 22 | 43 | 0.22 | 0.17 | 45 | 8.0 | 0.78 | 0.62 |
| 18 | 30 | 20 | L to H | 22 | 44 | 0.21 | 0.16 | 48 | 7.1 | 0.76 | 0.63 |
| 19 | 30 | 20 | L to H | 22 | 45 | 0.20 | 0.16 | 49 | 6.7 | 0.79 | 0.67 |
| 20 | 30 | 20 | L to H | 23 | 47 | 0.15 | 0.16 | 51 | 7.1 | 1.07 | 0.69 |
| 21 | 30 | 20 | L to H | 8 | 21 | 0.68 | 0.70 | 62 | 11.0 | 1.03 | 0.63 |
| 22 | 30 | 20 | L to H | 22 | 46 | 0.19 | 0.16 | 53 | 7.0 | 0.83 | 0.68 |
| 23 | 30 | 20 | L to H | 22 | 46 | 0.18 | 0.16 | 53 | 6.9 | 0.88 | 0.70 |
| 24 | 30 | 20 | L to H | 23 | 47 | 0.20 | 0.16 | 51 | 6.7 | 0.79 | — |
| Com. Ex. 3 | 37 | 25 | H to L | 46 | 12 | 0.54 | 0.73 | 75 | 8.2 | 1.35 | — |
| 25--2 | 30 | 20 | L to H | 22 | 38 | 0.26 | 0.19 | 41 | 8.2 | 0.73 | 0.44 |

### Example 29

An optical recording medium of DVD+R was produced and evaluated in the same manner as Example 1 except that the No. 21 cyanine dye shown above as a dye material (A), the No. 11 squarylium chelate dye as a dye material (B), the dithiol Ni complex shown above as a light resistant material (C), and the No. 26 formazan chelate dye as a light resistant material (D) were dissolved into 2,2,3,3-tetrafluoropropanol in a mass ratio of A/B/C/D=5/2.5/1.7/0.8 thereby to prepare a coating liquid for the dye recording layer.

Consequently, it was confirmed that the reflectance before recording was 22% and the reflectance after recording was 44% at recording mark portions and the optical recording medium was of low-to-high type; the modulation degree was 0.48 and the jitter was 7.1%. It was also confirmed that the push-pull signal before recording was 0.21 and the push-pull signal after recording was 0.16 thus the push-pull signal decreases after recording.

### Example 30

An optical recording medium of DVD-R was produced in the same manner as Example 29 except that the format of the substrate 1 was changed into one in accordance with DVD-R format.

The optical recording medium was evaluated for its properties using a disc evaluation device ODU-1000 (by Pulstec Industrial Co.) in accordance with the evaluating conditions of the system specifications in DVD Specification for Recordable Disc for General/Part 1, Ver. 2.0.

As for signal recording, DVD (8-16) signals were recorded under the conditions of wavelength: 659 nm, NA: 0.65, and linear velocity: 8× (27.92 m/s). In the recording, a castle pattern of pulse light emission was employed in accordance with the DVD-R specifications.

As for signal reproduction, unrecorded and recorded signals were measured under a condition of wavelength: 659 nm, NA: 0.65, and linear velocity: 1× (3.49 m/s).

In addition, the processes to measure reflectance, signal modulation degree, jitter, push-pull signal, etc. were based on the DVD-R system specifications.

Consequently, it was confirmed that the reflectance before recording was 22% and the reflectance after recording was 44% at recording mark portions and the recording was of low-to-high mode in which the reflectance increases after recording; the modulation degree was 0.48 and the jitter was 7.1%.

It was also confirmed that the push-pull signal before recording was 0.21 and the push-pull signal after recording was 0.16 thus the push-pull signal decreases after recording.

### Example 31

An optical recording medium of DVD+R was produced in the same manner as Example 19 except that the groove depth of the substrate 1 was changed into 300 Å.

Consequently, it was confirmed that the optical recording medium was of low-to-high type such that the reflectance before recording was 22% and the reflectance after recording was 46% at recording mark portions. It was also confirmed that the push-pull signal before recording was 0.20, the push-pull signal after recording was 0.16, PPa/PPb was 0.79, the push-pull signal was no more than 0.3 after recording, and the push-pull signal after recording was lower than that of before recording. The modulation degree was 0.50, the jitter was 6.9%, and RCa was −0.05.

### Comparative Example 5

A commercially available DVD-ROM disc was reproduced by the evaluation device used in Example 29 and the push-pull signal was measured to be 0.30, which demonstrating that the optical recording medium of Example 29 represents the push-pull signal lower than that of the commercially available DVD-ROM.

### Example 32

A polycarbonate disc of 120 mm diameter and 0.57 mm thick was obtained as a first substrate 11, in which a spiral pattern of track pitch 0.74 μm was formed on the surface by guide grooves with about 350 Å deep and about 0.24 μm of groove bottom width.

Then a cyanine dye (compound No. 21) as a dye material (A), a squarylium dye (compound No. 8 in Table 1) as a dye material (B), and a formazan chelate dye (compound No. 26) as a light resistant material (C) were dissolved into 2,2,3,3-tetrafluoropropanol in a mass ratio of 4:3:3 thereby to prepare a coating liquid for the material of a first dye recording layer 12, which was then spin-coated on the first substrate 11 and annealed at 90° C. for 15 minutes thereby to form a first dye recording layer 12.

On the first dye recording layer 12, a Ag—In alloy (In: 5% by mass) was deposited to about 9 nm thick by a sputtering process using Ar as a sputtering gas to form a semi-transmissive reflective layer 13. The transmittance of the semi-transmissive reflective layer 13 was about 50%.

On the other hand, a polycarbonate disc of 120 mm diameter and 0.57 mm thick was obtained as a second substrate 18 in which a spiral pattern of track pitch 0.74 μm was formed on the surface by guide grooves with about 300 Å deep and about 0.24 μm of groove bottom width.

A reflective layer 17 of Ag was formed to about 100 nm thick on the second substrate 18 by a sputtering process using Ar as a sputtering gas.

Then a cyanine dye (compound No. 21) as a dye material (A) and a squarylium dye as a dye material (B) (compound No. 8 in Table 1) were dissolved into 2,2,3,3-tetrafluoropropanol in a mass ratio of 6:4 thereby to prepare a coating liquid for the material of a second dye recording layer 16, which was then spin-coated on the reflective layer 17 and annealed at 90° C. for 15 minutes thereby to form a second dye recording layer 16.

Then on the second dye recording layer 16, ZnS—SiO₂ (8:2 by mole ratio) was deposited to about 15 nm thick by a sputtering process using Ar as a sputtering gas to form an inorganic protective layer 15.

Then the first substrate 11 and the second substrate 18 were laminated by use of a UV curable adhesive (KARAYADDVD003, by Nippon Kayaku Co.) thereby to produce an optical recording medium having a layer construction shown in FIG. 4.

### Example 33

An optical recording medium was produced in the same manner as Example 32 except that the second substrate 18 was changed into one in which a spiral pattern of track pitch 0.74 μm was formed by guide grooves with about 150 Å deep and about 0.25 μm of groove bottom width.

### Example 34

An optical recording medium was produced in the same manner as Example 32 except that the dye material (B) of the second dye recording layer 16 was changed into the cyanine dye (compound No. 22).

### Example 35

An optical recording medium was produced in the same manner as Example 34 except that the second substrate 18 was changed into one in which a spiral pattern of track pitch 0.74 μm was formed by guide grooves with about 150 Å deep and about 0.25 μm of groove bottom width.

### Example 36

An optical recording medium was produced in the same manner as Example 32 except that the dye material (A) was changed into the cyanine dye (compound No. 25) and the dye material (B) was changed into the squarylium chelate dye (compound No. 2 in Table 1) of the second dye recording layer 16.

### Example 37

An optical recording medium was produced in the same manner as Example 36 except that the second substrate 18 was changed into one in which a spiral pattern of track pitch 0.74 μm was formed by guide grooves with about 150 Å deep and about 0.25 μm of groove bottom width.

### Example 38

An amorphous polyolefin (Zeonex, by Zeon Co.) was injection-molded to make a resin stamper of diameter 120 mm and 0.6 mm thick in which a spiral pattern of track pitch 0.74 μm was formed by guide grooves with about 400 Å deep and about 0.24 μm of groove bottom width (intermediate layers being transferred to have a groove bottom width of 0.24 μm).

A polycarbonate disc of 120 mm diameter and 0.57 mm thick was obtained as a first substrate 11, in which a spiral pattern of track pitch 0.74 μm was formed on the surface by guide grooves with about 350 Å deep and about 0.24 μm of groove bottom width.

Then a cyanine dye as a dye material (A) (compound No. 21), a squarylium dye as a dye material (B) (compound No. 8 in Table 1), and a formazan chelate dye as a light resistant material (C) (compound No. 26) were dissolved into 2,2,3,3-tetrafluoropropanol in a mass ratio of 4:3:3 thereby to prepare a coating liquid for the material of a first dye recording layer 12, which was then spin-coated on the first substrate 11 and annealed at 90° C. for 15 minutes thereby to form a first dye recording layer 12.

On the first dye recording layer 12, a Ag—In alloy (In: 5% by mass) was deposited to about 900 nm thick by a sputtering process using Ar as a sputtering gas to form a semi-transmissive reflective layer 13. The transmittance of the semi-transmissive reflective layer 13 was about 50%.

Then a UV curable resin was coated to about 50 μm thick on the semi-transmissive reflective layer 13, and the resin stamper was placed to face toward the layer of the UV curable resin.

After UV rays were irradiated from the side of the resin stamper to cure the UV curable resin, the resin stamper was peeled to form an intermediate layer 19 having guide groves with concavo-convex transferred thereon.

Then a cyanine dye as a dye material A (compound No. 21) and a squarylium dye as a dye material B (compound No. 8 in Table 1) were dissolved into 2,2,3,3-tetrafluoropropanol in a mass ratio of 6:4 thereby to prepare a coating liquid for the material of a second dye recording layer 16, which was then spin-coated on the intermediate layer 19 and annealed at 90° C. for 15 minutes thereby to form a second dye recording layer 16.

A reflective layer 17 of Ag was formed to about 100 nm thick on the second dye recording layer 16 by a sputtering process using Ar as a sputtering gas.

A polycarbonate disc of 120 mm diameter and 0.57 mm thick was obtained as a second substrate 18, in which a spiral pattern of track pitch 0.74 μm was formed on the surface by guide grooves with about 300 Å deep and about 0.24 μm of groove bottom width.

Then the first substrate 11 and the second substrate 18 were laminated by use of a UV curable adhesive (KARAYADDVD003, by Nippon Kayaku Co.) thereby to produce an optical recording medium having a layer construction shown in FIG. 5.

### Comparative Example 6

An optical recording medium having a layer construction shown in FIG. 4 was produced in the same manner as Example 32 except that the groove depth of the first substrate 11 was changed into about 1500 Å, the dye material (A) of the first dye recording layer was changed into the cyanine dye (compound No. 19), the dye material (A) of the second dye recording layer was changed into the cyanine dye (compound No. 19), and the dye material (B) was changed into the squarylium dye (compound No. 2).

The optical recording media of Examples 32 to 38 (optical recording media of this embodiment) and the optical recording media of Comparative Example 6 were evaluated for their properties in the same manner as Example 1. Table 6 shows the conditions of the materials of the dye recording layers and substrate structure and the results of measurement, and Table 7 shows the properties of the recording layers.

From the results shown in Table 7, it was confirmed that the first dye recording layers as well as the second dye recording layers represent a reflectance after recording larger than the reflectance before recording thus the optical recording media of this embodiment are those of low-to-high type and that the push-pull signal before recording is smaller than the push-pull signal after recording.

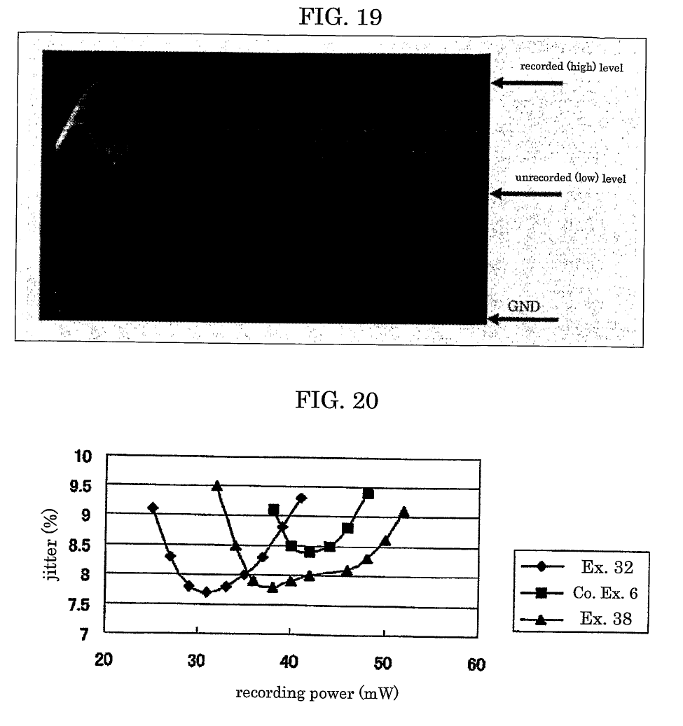

FIG. 19 shows the wave profile (eye pattern) of reproduction signal of the optical recording medium of Example 32 under the recording/reproducing condition. Although the measurements were carried out using a recording/reproducing light of wavelength 659 nm, similar results are obtainable even when the wavelength of the recording/reproducing light is fluctuated about ±20 nm. The reason is that the light absorption of the dye materials (A) in the optical recording media of this embodiment gently alternates in a range of 640 to 680 nm meanwhile the light absorption of conventional DVD+R of high-to-low type rapidly alternates at the DVD laser light wavelength of about 650 nm.

On the contrary, it was confirmed that the optical recording medium of Comparative Example 6 is of high-to-low type and that the push-pull signal after recording is larger than the push-pull signal before recording.

Jitter margin to recording power was evaluated with respect to the second dye recording layers of Examples 32 and 38, and Comparative Example 6.

The results shown in FIG. 20 demonstrate that the optical recording media of Examples 32 and 38 have an excellent power margin compared to that of Comparative Example 6.

In addition, wavelength-dependent parameter “n” of the second dye recording layer was calculated as regards the optical recording media of Example 32 and Comparative Example 6.

The results demonstrate that the wavelength-dependency is more excellent for the optical recording medium of Example 32 such that “n” of Example 32 was “−1” and “n” of Comparative Example 6 was “+23”.

As explained above, the optical recording media of this embodiment have the dye recording layers 12, 16 of low-to-high type, accordingly, such problems can be avoided as recording sensitivity decreases when information is rapidly recorded or push-pull signal comes to unduly large at reproducing information thereby to enhance recording/reproducing properties. Specifically, noises due to reflective light from the grooves of the substrates 11, 18 can be avoided from including into reproduction signals.

In addition, the optical recording media of this embodiment have a value of push-pull signal of no more than 0.45, accordingly, noises due to reflective light from the grooves of the substrates 11, 18 can be avoided from including into reproduction signals.

Furthermore, the optical recording media of this embodiment have dye recording layers 12, 16 of low-to-high type, therefore, information can be recorded and reproduced in optical recording/reproducing apparatuses that recognize the optical recording medium as read-only when the values of push-pull signal are within the first range and as recordable when the values of push-pull signal are within the second range larger than the first range. Specifically, the value of push-pull signal based on reflective light from the first and the second dye recording layers 12, 16 is set within the first range before recording information and the value of push-pull signal is set within the second range after recording information, thereby the optical recording apparatuses can record and reproduce information on the optical recording media of this embodiment. These optical recording media have been demanded in a technical sense to prevent illegal copies as described above; in the optical recording media of this embodiment, the push-pull signal decreases after recording information, therefore, information can be reproduced as in a read-only DVD even after recording information.

Furthermore, in the optical recording media of this embodiment, the modulation degree of the first dye recording layer 12 and the second dye recording layer 16 is 40% or more. Therefore the information on the optical recording media can be appropriately reproduced since S/N ratio of the reproduction signals is adequate. Furthermore, the system specifications of DVD+R, HD DVD-R, BD-R, etc. require the modulation degree of reproduction signals to be 40% or more, and the optical recording media are adapted to the system specifications, thus existing drives can be easily set for recording and reproducing.

Furthermore, in the optical recording media of this embodiment, the light absorptance (Abs.) of the first dye recording layers 12 as well as the second dye recording layers 16 is within a range of 0.2 to 0.8 at the recording/reproducing light. Therefore, the reflectances of the optical recording media can be sufficiently assured and the sensitivity of dye recording layers and the modulation degree of reproduction signals necessary for recording can be sufficiently assured. That is, the optical recording media of this embodiment are particularly advantageous over the conventional optical recording media of high-to-low type such as conventional DVD+R and DVD-R in order to enhance the recording sensitivity since their light absorptance (Abs.) is below 0.2.

TABLE 6

| | | | | | | | | λmax (nm) | | | | | |
|---|---|---|---|---|---|---|---|---|---|---|---|---|---|
| | | | | light | | | | | | light | | | |
| | | | | resistant | | | groove | | | resistant | | | |
| | | | | material | ratio | groove | width | | | material | Abs (λmax) | | Abs |
| | Example | dye (A) | dye (B) | (C) | (A/B/C) | depth | (μm) | dye (A) | dye (B) | (C) | dye (A) | dye (B) | (650 nm) |
| first dye | Ex. 32 to 38 | No. 21 | No. 8 | No. 26 | 4/3/3 | 350 Å | 0.24 | 728 | 619 | 548 | 0.58 | 0.36 | 0.39 |
| recording layer | Com. Ex. 6 | | No. 19 | No. 26 | 0/7/3 | 1600 Å | 0.24 | | 606 | 548 | | 0.60 | 0.13 |
| second dye | Ex. 32 | No. 21 | No. 8 | | 6/4/0 | 300 Å | 0.24 | 728 | 619 | | 0.58 | 0.36 | 0.56 |
| recording layer | Ex. 33 | No. 21 | No. 8 | | 6/4/0 | 150 Å | 0.24 | 728 | 619 | | 0.58 | 0.36 | 0.55 |
| | Ex. 34 | No. 21 | No. 22 | | 7/3/0 | 300 Å | 0.24 | 728 | 616 | | 0.59 | 0.32 | 0.60 |
| | Ex. 35 | No. 21 | No. 22 | | 7/3/0 | 150 Å | 0.24 | 728 | 616 | | 0.59 | 0.32 | 0.59 |
| | Ex. 36 | No. 25 | No. 2 | | 6/4/0 | 300 Å | 0.24 | 722 | 601 | | 0.52 | 0.34 | 0.55 |
| | Ex. 37 | No. 25 | No. 2 | | 6/4/0 | 150 Å | 0.24 | 722 | 601 | | 0.52 | 0.34 | 0.54 |
| | Ex. 38 | No. 21 | No. 8 | | 6/4/0 | 400 Å | 0.24 | 728 | 619 | | 0.58 | 0.36 | 0.56 |
| | Com. Ex. 6 | No. 19 | No. 2 | | 6/4/0 | 300 Å | 0.24 | 606 | 601 | | 0.60 | 0.34 | 0.18 |

TABLE 7

| | | recording | | | | | | | | | |
|---|---|---|---|---|---|---|---|---|---|---|---|
| | | power | | | | | | | modulation | | |
| | | (mW) | | recording | reflectance (%) | | push-pull | | degree (%) | jitter | PPa/PPb * |
| | | W1 | W2 | mode | unrecorded | recorded | unrecorded | recorded | I14/I14H | (%) | (%) |
| first dye | Ex. 32 to 38 | 27 | 18 | L to H | 7 | 18 | 0.23 | 0.21 | 61 | 7.5 | 0.91 |
| recording | Com. Ex. 6 | 42 | 30 | H to L | 18 | 17 | 0.30 | 0.36 | 69 | 8.2 | 1.20 |
| layer | | | | | | | | | | | |
| second | Ex. 32 | 31 | 21 | L to H | 7 | 16 | 0.24 | 0.22 | 62 | 7.7 | 0.92 |
| dye | Ex. 33 | 31 | 21 | L to H | 8 | 18 | 0.17 | 0.16 | 62 | 7.6 | 0.94 |
| recording | Ex. 34 | 30 | 20 | L to H | 6 | 15 | 0.24 | 0.22 | 61 | 7.5 | 0.92 |
| layer | Ex. 35 | 30 | 20 | L to H | 7 | 17 | 0.17 | 0.16 | 60 | 7.4 | 0.94 |
| | Ex. 36 | 32 | 22 | L to H | 8 | 17 | 0.24 | 0.22 | 64 | 7.9 | 0.92 |
| | Ex. 37 | 32 | 22 | L to H | 9 | 19 | 0.17 | 0.16 | 64 | 7.8 | 0.94 |
| | Ex. 38 | 38 | 28 | L to H | 5 | 15 | 0.22 | 0.20 | 61 | 7.8 | 0.91 |
| | Com. Ex. 6 | 42 | 28 | H to L | 19 | 18 | 0.33 | 0.37 | 72 | 8.4 | 1.12 |

1. An optical recording medium, comprising a dye recording layer,
wherein a recording mark portion is formed at the dye recording layer by use of a laser light having a wavelength of 640 nm to 680 nm, and a reflectance after recording with respect to the laser light at the recording mark portion is increased compared to a reflectance before recording.

2. The optical recording medium according to claim 1, wherein a push-pull signal (push-pull (differential signal)/reflectance (sum signal)) after recording at the recording mark portion is decreased compared to a push-pull signal (push-pull (differential signal)/reflectance (sum signal)) before recording.

3. An optical recording medium, comprising a dye recording layer,
wherein a recording mark portion is formed at the dye recording layer by use of a laser light having a wavelength of 400 nm to 410 nm, a reflectance after recording with respect to the laser light at the recording mark portion is increased compared to a reflectance before recording, and a push-pull signal (push-pull (differential signal)/reflectance (sum signal)) after recording is decreased compared to a push-pull signal (push-pull (differential signal)/reflectance (sum signal)) before recording.

4. The optical recording medium according to claim 1, wherein the dye recording layer contains one or more dye materials (A) that have a maximum absorption peak wavelength longer than a recording/reproducing wavelength and one or more dye materials (B) that have a maximum absorption peak wavelength shorter than the recording/reproducing wavelength.

5. The optical recording medium according to claim 4, wherein the dye material (A) is a cyanine dye expressed by General Formula (I) shown below: 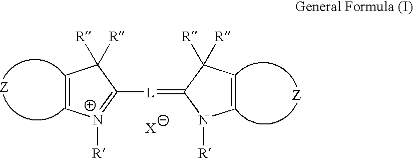
where R′ and R″ each independently represents an alkyl group, an aralkyl group, or an aryl group that may be substituted by a substituent, and adjacent R″s may be linked together to form an alicyclic hydrocarbon ring or a heterocyclic ring; Z represents a group of atoms to form an aromatic ring, X represents a monovalent anion, and L represents a connecting group to form a carbocyanine.

6. The optical recording medium according to claim 4, wherein the dye material (B) is a squarylium dye expressed by General Formula (II) below: 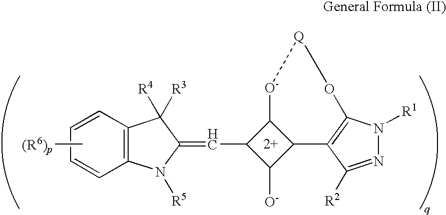
in the formula above, R¹ and R², which may be identical or different, each represents a hydrogen atom, an alkyl group that may have a substituent, an aralkyl group that may have a substituent, an aryl group that may have a substituent, or a heterocyclic group that may have a substituent; Q represents a metal atom capable of coordinating; q is an integer of 2 or 3; R³ and R⁴, which may be identical or different, each represents a hydrogen atom, an alkyl group that may have a substituent, an aralkyl group that may have a substituent, or an aryl group that may have a substituent, and R³ and R⁴ may be linked together to form an alicyclic hydrocarbon ring or a heterocyclic ring; R⁵ represents a hydrogen atom, an alkyl group that may have a substituent, an aralkyl group that may have a substituent, or an aryl group that may have a substituent; R⁶ represents a halogen atom, an alkyl group that may have a substituent, an aralkyl group that may have a substituent, an aryl group that may have a substituent, a nitro group, a cyano group, or an alkoxy group that may have a substituent; p is an integer of 0 to 4, and when p is 2 to 4, R⁶s may be identical or different and two neighboring R⁶s and adjacent two carbon atoms may form an aromatic ring that may have a substituent.

7. The optical recording medium according to claim 1, wherein a light absorbance (Abs.) at a wavelength 660 nm is larger than a light absorbance (Abs.) at a wavelength 650 nm in the dye recording layer.

8. The optical recording medium according to claim 1, wherein a reflectance with respect to a laser light of a wavelength 650 nm is larger than a reflectance with respect to a laser light of a wavelength 660 nm in the dye recording layer.

9. The optical recording medium according to claim 1, wherein a wavelength-dependent parameter (“n” expressed by the formula below), calculated in the wavelength region of 645 nm to 670 nm, is −25 to +25,
n=(dPw/dλ)/(Pw at 655 nm)/655)
where (dPw/dλ) denotes a change in the value of recording power per 1 nm change in wavelength, and (Pw at 655 nm) is a recording power necessary to record at wavelength 655 nm.

10. The optical recording medium according to claim 1, comprising a substrate having a surface on which spiral grooves and lands between the grooves are formed, wherein the spiral grooves wobble along a radial direction with a track pitch of 0.74±0.03 μm, at least the dye recording layer and a light reflective layer are laminated in order thereon, and additional information is recorded at the grooves and/or lands.

11. The optical recording medium according to claim 10, wherein the information indicating that the reflectance after recording is higher than the reflectance before recording at the recording mark portion is recorded as the additional information.

12. The optical recording medium according to claim 1, wherein the optical recording medium comprises a substrate on which the dye recording layer is formed and has a groove at the surface of the substrate, and the depth of the groove is 20 nm to 100 mm.

13. The optical recording medium according to claim 1, comprising in order a first information layer having a first recording layer of the dye recording layer and a second information layer having a second recording layer of the dye recording layer, from an incident side of laser light,
wherein the depth of the groove at a surface of a first substrate of the first information layer is 20 nm to 100 nm and the depth of the groove at a surface of a second substrate of the second information layer is 10 nm to 40 nm, and respective half-value widths of each groove width are 20% to 60% of each track pitch.

14. The optical recording medium according to claim 1, wherein an access region which is to be accessed when reproducing and which is other than data regions, is already recorded.

15. The optical recording medium according to claim 14, wherein the access region comprises a region within an area having a radius of 24 mm.

16. The optical recording medium according to claim 15, wherein the region within an area having a radius of 24 mm comprises a recording region to manage recording that is set in the optical recording medium.

17. An optical recording apparatus, comprising:
a recording unit configured to record information on an optical recording medium, and
a distinguishing unit configured to distinguish whether or not the optical recording medium, which is mounted in the optical recording apparatus, is of low-to-high type in which a reflectance after recording at a recording mark portion with respect to laser light is increased compared to a reflectance before recording,
wherein the recording unit makes an access region which is to be accessed when reproducing and which is other than data regions, recorded in the optical recording medium when the distinguishing unit distinguishes the optical recording medium as low-to-high type.

18. The optical recording apparatus according to claim 17,
wherein the recording unit makes the access region which is to be accessed when reproducing and which is other than data regions, recorded and records contents information acquired through the network, when the distinguishing unit distinguishes the optical recording medium as low-to-high type.
